(19) United States
(12) Patent Application Publication
(10) Pub. No.: US 2025/0236561 A1
(43) Pub. Date: Jul. 24, 2025

(54) PRECERAMIC RESINS AND POROUS POLYMER-DERIVED CERAMICS

(71) Applicant: University of Tasmania, Tasmania (AU)

(72) Inventors: Vipul Gupta, Tasmania (AU); Ahmad Reza Norouzi, Tasmania (AU)

(21) Appl. No.: 18/844,823

(22) PCT Filed: Mar. 8, 2023
(86) PCT No.: PCT/AU2023/050161

§ 371 Date: Sep. 6, 2024

(30) Foreign Application Priority Data
Mar. 8, 2022 (AU) 2022900557

(51) Int. Cl. C04B 35/571; B33Y 10/00; B33Y 70/10; C04B 38/08; C08F 222/10; C08G 77/20; C08G 77/28; C08K 3/36

(52) U.S. Cl. CPC C04B 35/571; C04B 38/085; C08F 222/102; C08G 77/20; C08G 77/28; C08K 3/36; B33Y 10/00; B33Y 70/10; C04B 2235/3418; C04B 2235/483; C04B 2235/5454; C04B 2235/6022; C08K 2201/005; C08K 2201/011

(57) ABSTRACT

The present disclosure relates to organosilicon preceramic resin compositions for forming porous polymer-derived ceramic materials. It also relates to porous organosilicon polymer-derived ceramic materials, and methods for forming porous organosilicon polymer-derived ceramic materials.

### RELATED APPLICATIONS

This application claims the benefit of Australian Provisional Patent Application No 2022900557, filed on 8 Mar. 2022, which is incorporated herein by reference in its entirety.

### TECHNICAL FIELD

The present invention relates to organosilicon preceramic resin compositions for forming porous polymer-derived ceramic materials. It also relates to porous organosilicon polymer-derived ceramic materials, and methods for forming porous organosilicon polymer-derived ceramic materials.

### BACKGROUND ART

Ceramic material articles are widely used in various socio-economically important applications, such as sustainable energy production and storage, drug development, environment and health monitoring and engineering fields. Specific applications include high-speed impellers, heat shielding and wear-resistant parts. Their use arises from ceramic materials generally being characterised by impressive thermal stability and mechanical strength. However, because of this, they are difficult to machine into specific shapes required for their various applications.

This has been aided by the development of polymer-derived ceramic (PDC) material materials which allow pre-shaping of a softer, more malleable preceramic polymeric precursor before converting the shaped article into a ceramic.

The common process for making PDC materials involves subjecting a preceramic polymer article to pyrolytic conditions at temperatures in excess of 1000° C. This causes a thermally-induced conversion from organic to inorganic (i.e. ceramic) material and thermal decomposition of certain components of the preceramic polymer. Decomposition tends to release gases which may include carbon dioxide, carbon monoxide, methane, water and others. This tends to produce solid, nonporous PDC materials.

Some porous ceramic articles have been manufactured at small scale. These ceramic materials are mostly made using soft or hard templates (including biotemplates), sol-gel processes, phase separation, or chemical etching, all of which are difficult to implement. They are also limited to the formation of relatively simple articles and offer limited control over, and a limited extent of, porosity.

Ceramic manufacturing has been assisted by the recent advent of 3D printing in which a preceramic polymer, silane, or a ceramic and organic binder composite is printed to shape prior to pyrolysis or sol-gel processing. However, 3D printing of ceramics is still in its infancy. Most of the ceramic 3D printing methods have been limited to the use of direct ink writing technique, which restricts their use to the formation of relatively simple and non-porous articles. More recently, photopolymerisation based 3D printing techniques, such as stereolithography, that circumvents the limitations of direct ink writing, have been explored to produce ceramic articles. However, these methods have used phase-separating resins resulting in high linear shrinkage and lack of porosity.

Ceramic materials have impressive properties that are desirable to implement in many other fields of endeavour, though limitations in their physical structure including lack of porosity, and difficult methods of manufacture, prevent them from being adopted in a broader array of applications. It would be beneficial to provide preceramic resins for the production of alternative PDC materials that may be utilised in new and existing applications. It would also be beneficial to provide effective methods for their manufacture.

### SUMMARY

The present invention is predicated on the acquired knowledge that certain components used in a preceramic resin give rise to porous PDC materials formed from the resin by a process including polymerisation and pyrolysis.

In one aspect, the present invention provides a preceramic resin for forming a porous polymer-derived ceramic material, the resin comprising:
a) a first functionalised organosilicon monomer having a first ceramic yield; and
b) one or more of:
   i. a second functionalised organosilicon monomer having a second ceramic yield;
   ii. a functionalised organic monomer;
   iii. porous ceramic particles; and
   iv. a porogen.

In particular embodiments, the preceramic resin comprises one of the following combinations selected from (a) to (g) below:
a) a first functionalised organosilicon monomer having a first ceramic yield and one or both of a second functionalised organosilicon monomer having a second ceramic yield and a functionalised organic monomer;
b) a first functionalised organosilicon monomer having a first ceramic yield and porous ceramic particles;
c) a first functionalised organosilicon monomer having a first ceramic yield and a porogen;
d) a first functionalised organosilicon monomer having a first ceramic yield, porous ceramic particles and a porogen;
e) a first functionalised organosilicon monomer having a first ceramic yield, one or both of a second functionalised organosilicon monomer having a second ceramic yield and a functionalised organic monomer, and porous ceramic particles;
f) a first functionalised organosilicon monomer having a first ceramic yield, one or both of a second functionalised organosilicon monomer having a second ceramic yield and a functionalised organic monomer, and a porogen;
g) a first functionalised organosilicon monomer having a first ceramic yield, one or both of a second functionalised organosilicon monomer having a second ceramic yield and a functionalised organic monomer, porous ceramic particles and a porogen.

In another aspect, the present invention provides a porous polymer-derived ceramic material formed from a preceramic resin as described herein.

In another aspect, the present invention provides a porous polymer-derived ceramic material characterised by a specific surface area of greater than or equal to 70 m²/g.

In another aspect, the present invention provides a microporous polymer-derived ceramic material.

In another aspect, the present invention provides a porous polymer-derived ceramic material as described herein, formed from a preceramic resin as described herein.

In another aspect, the present invention provides a porous polymer-derived ceramic material, said method comprising:
a) subjecting a preceramic resin for forming a porous polymer-derived ceramic material to polymerising conditions to form a preceramic polymer; and
b) subjecting the preceramic polymer to pyrolytic conditions,
wherein formation of the polymer-derived ceramic material from the preceramic polymer proceeds through a porous phase, and wherein the pyrolytic conditions are characterised by a maximum temperature within the porous phase.

In another aspect, the present invention provides a method for forming a porous polymer-derived ceramic material, said method comprising:
a) subjecting a preceramic resin for forming a porous polymer-derived ceramic material to polymerising conditions to form a preceramic polymer; and
b) subjecting the preceramic polymer to pyrolytic conditions to form a porous polymer-derived ceramic material,
wherein the pyrolytic conditions are characterised by a maximum temperature of no greater than about 1000° C.

In another aspect, the present invention provides a method for forming a porous polymer-derived silica ceramic material, said method comprising:
a) subjecting a preceramic resin for forming a porous polymer-derived silica ceramic material to polymerising conditions to form a preceramic polymer; and
b) subjecting the preceramic polymer to pyrolytic conditions,
wherein formation of the polymer-derived silica ceramic material from the preceramic polymer proceeds through a porous phase, wherein the pyrolytic conditions are characterised by the presence of oxygen and a maximum temperature within the porous phase,
and wherein the preceramic resin comprises:
a) a first functionalised polycarbosiloxane or polycarbosilane monomer having a first ceramic yield; and
b) one or more of:
   i. a second functionalised organosilicon monomer having a second ceramic yield;
   ii. porous ceramic particles; and
   iii. a porogen.

In another aspect, the present invention provides a polymer-derived ceramic material formed from a method as described herein.

### DESCRIPTION OF THE FIGURES

FIG. 1 shows 3D printed and injection moulded porous silicon oxycarbide PDC articles of Example 1: (a) 3D printed green body, (b) pyrolysed 3D printed body, (c) injection moulded green body, and (d) pyrolysed injection moulded body.

FIG. 2 shows 3D printed and injection moulded porous silicon oxycarbide PDC articles of Example 2: (a) 3D printed green body, (b) pyrolysed 3D printed body, (c) injection moulded green body, and (d) pyrolysed injection moulded body.

FIG. 3 is a pore size distribution plot of the 3D printed silicon oxycarbide PDC article of Example 2 as determined using a BET surface analyser.

FIG. 4 shows the 3D printed porous silicon oxycarbide PDC article of Example 3: (a) 3D printed green body and (b) pyrolysed 3D printed body.

FIG. 5 shows 3D printed and injection moulded porous silicon dioxide PDC articles of Example 4: (a) 3D printed green body, (b) pyrolysed 3D printed body, (c) moulded green body, and (d) pyrolysed injection moulded body.

FIG. 6 shows 3D printed and injection moulded porous silicon dioxide PDC articles of Example 5: (a) 3D printed green body, (b) pyrolysed 3D printed body, (c) injection moulded green body, (d) pyrolysed injection moulded body.

FIG. 7 is a pore size distribution plot of the 3D printed silicon dioxide PDC article of Example 5 as determined using a BET surface analyser.

FIG. 8 is a pore size distribution plot of the 3D printed silicon dioxide PDC article of Example 5 as determined using mercury porosimetry.

FIG. 9 shows 3D printed and injection moulded porous silicon dioxide PDC articles of Example 6: (a) 3D printed green body, (b) pyrolysed 3D printed body, (c) moulded green body, and (d) pyrolysed moulded body.

FIG. 10 shows the injection moulded silicon oxycarbide PDC article of Example 7: (a) green body and (b) pyrolysed body.

FIG. 11 shows the injection moulded porous silica PDC article of Example 8: (a) green body and (b) pyrolysed body.

FIG. 12 shows the injection moulded porous silicon dioxide PDC article of Example 9: (a) moulded green body and (b) pyrolysed body.

FIG. 13 shows the injection moulded porous silicon dioxide PDC article of Example 10: (a) moulded green body and (b) pyrolysed body.

FIG. 14 shows the injection moulded porous silica PDC article of Example 11: (a) green body and (b) pyrolysed body.

FIG. 15 depicts Scanning Electron Microscopy (SEM) images of a pyrolysed 3D printed microneedle showing micropores.

FIG. 16 depicts the characterisation of a preceramic resin used to form the pyrolysed 3D printed microneedle of FIG. 15 and the resulting silicon oxcycarbide PDC material: (a) TGA of the resin, (b) EDEX (elemental analysis) of the pyrolysed body, and (c) X-ray powder diffraction (XRD) of the pyrolysed body.

FIG. 17 depicts SEM images of a pyrolysed 3D printed microneedle showing micropores and mesopores.

FIG. 18 depicts the characterisation of a preceramic resin used to form the pyrolysed 3D printed microneedle of FIG. 17 and the resulting silicon oxcycarbide PDC material: (a) TGA of the resin, (b) EDEX (elemental analysis) of the pyrolysed body, and (c) X-ray powder diffraction (XRD) of the pyrolysed body.

FIG. 19 depicts SEM images of a pyrolysed 3D printed microneedle showing micropores, mesopores and macropores.

FIG. 20 depicts the characterisation of a preceramic resin used to form the pyrolysed 3D printed microneedle of FIG. 19 and the resulting silicon oxcycarbide PDC material: (a) TGA of the resin, (b) EDEX (elemental analysis) of the pyrolysed body, and (c) X-ray powder diffraction (XRD) of the pyrolysed body.

FIG. 21 depicts images of a pyrolysed 3D printed leaf article (top row) and insect wing article (bottom row) replicating naturally occurring porous structures, together with SEM images of two stages of magnification of portions of those articles.

FIG. 22 depicts three progressively more magnified SEM images of a pyrolysed 3D printed diatom article replicating naturally occurring porous structures.

FIG. 23 shows on the right-side a 3D printed and shrink-fabricated porous ceramic microfluidic chip, and on the left side the corresponding green body from which the chip was produced following pyrolysis.

FIG. 24 is a pore size distribution plot of the 3D printed silicon oxycarbide PDC article of Example 12 as determined using a BET surface analyser.

FIG. 25 is a pore size distribution plot of the 3D printed silicon oxycarbide PDC article of Example 13 as determined using a BET surface analyser.

FIG. 26 is a pore size distribution plot of the 3D printed silicon oxycarbide PDC article of Example 14 as determined using a BET surface analyser.

FIG. 27 is a pore size distribution plot of the 3D printed silicon oxycarbide PDC article of Example 14 as determined using a Mercury Porosimeter.

### DETAILED DESCRIPTION

Unless defined otherwise, all technical and scientific terms used herein have the same meaning as commonly understood by those of ordinary skill in the art of the invention. Although any methods and materials similar or equivalent to those described herein can be used in the practice or testing of the present invention, preferred methods and materials are described. For the purposes of the present invention, a number of terms are defined throughout.

Manufactured ceramic materials are generally formed by a process which involves the polymerisation of suitable monomeric materials (which may constitute or form part of a preceramic resin) to form suitable polymeric materials, and pyrolysis of the polymeric materials. Generally speaking, during pyrolysis a preceramic resin is converted from an organic to an inorganic material. The inorganic material may exist in one or more material phases depending on the temperature to which the material is exposed. For instance, during pyrolysis temperature ramp-up, the inorganic material will generally first exist in an amorphous phase and then transition to a crystalline phase as the temperature increases. The present invention is directed towards resins comprising such monomeric materials that are suitable to be formed into polymeric materials and then into manufactured PDC materials that are porous. The pyrolytic conditions used to form porous materials, as described herein, tend to result in amorphous polymer-derived ceramic materials.

A “polymer-derived ceramic” (PDC) material is a manufactured ceramic material formed by pyrolysis of a preceramic polymer, and is as distinct from a naturally-occurring ceramic material.

The term “preceramic” confers a capability of being formed into a ceramic material using, either alone or with other steps of a method, a step of pyrolysis. Thus, a “preceramic polymer” is a polymeric material formed by subjecting a monomer to polymerising conditions, and which is capable of being pyrolysed into a ceramic material. In turn, a “preceramic resin” is a material or composition containing at least one monomer which is capable of being polymerised to form a preceramic polymer. Such a monomer may be referred to as a “preceramic monomer”.

A porous PDC material is one which contains pores. A “pore” is a space which is devoid of the solid material that makes up the material. In the PDC materials of the present invention, pores may be considered hierarchically in terms of pore size, as micropores, mesopores and macropores. A “micropore” refers to a pore with a diameter of less than 2 nm. A “mesopore” refers to a pore with a diameter of from 2 nm to 50 nm. A “macropore” refers to a pore with a diameter of from 50 nm to 100 micrometres. Macropores may further be considered as sub-, inter- and super-macropores, which refers to a macropore with a diameter of from 50 nm to 1 micrometre, from 1 micrometre to 10 micrometres, and from 10 micrometres to 100 micrometres, respectably. By “diameter” does not limit the shape of a pore and refers to the greatest axial dimension. Similarly, “microporous” refers to the containing of micropores, while “mesoporous” refers to the containing of mesopores, and “macroporous” refers to the containing of macropores. Pore size is experimentally determinable using methods known in the art. Known methods include gas adsorption (including using a BET surface analyser), scanning electron microscopy and liquid intrusion (including mercury porosimetry). Preferably, a BET surface analysis and/or mercury porosimetry is used for comparing pore sizes of different materials.

Depending on the composition of the preceramic resin, the porous PDC materials may be formed to contain micropores, mesopores and/or macropores (i.e. be microporous, mesoporous and/or macroporous). The different size pores may also be formed in different quantities. Together, this results in PDC materials formed with varying degrees of porosity. That is, by changing the relative amounts and/or components in the preceramic resin composition, one can design PDC materials with micropores, mesopores and/or macropores as desired to achieve a target porosity-they are “tunable”. This is explained in further detail below. In certain preferred embodiments, the formed porous PDC materials contain mesopores and one or both of micropores and macropores; i.e. are mesoporous and one or both of microporous and macroporous.

Porosity is directly related to specific surface area—the greater the porosity of a PDC material, the greater the specific surface area. Thus, the term “porosity” refers to a specific surface area of the PDC material. Specific surface area is experimentally determinable using methods known in the art including gas adsorption (including using a BET surface analyser) and liquid intrusion (including mercury porosimetry). Preferably, a BET surface analysis and/or mercury porosimetry should be used for comparing the porosity of different materials.

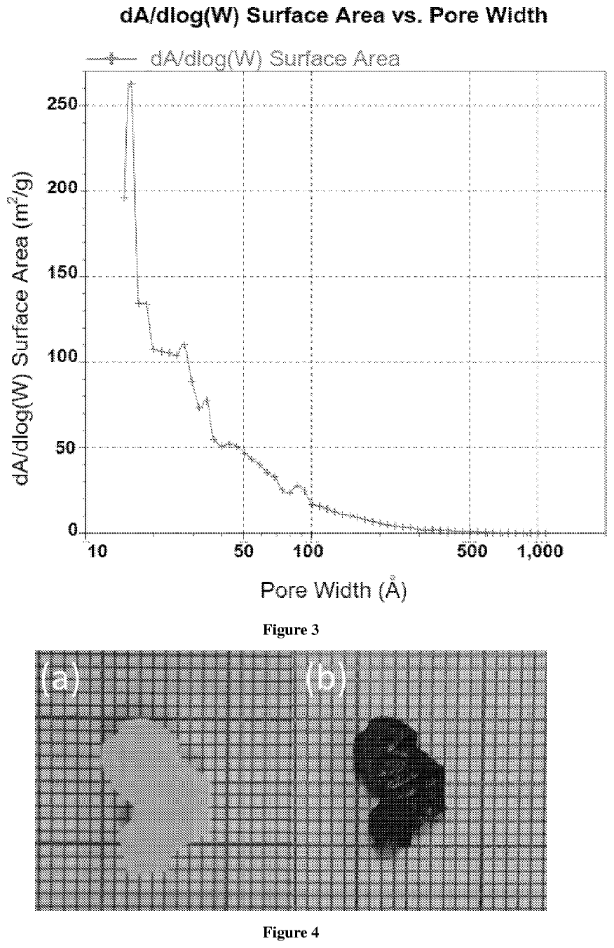

A BET surface analyser is generally considered to be capable of reliably analyzing micropores and mesopores. Mercury porosimetry is generally considered to be capable of reliably analyzing macropores. BET surface analysis generally relies on measurements of pressure as representative of gas (often N₂) adsorption and desorption, while mercury porosimetry generally relies on measurements of volume as representative of liquid ingress. Both test a sample of the PDC material, usually a sample of less than 100 mg. From both, pore size and specific surface area are calculable and presentable in a plot of specific surface area vs pore size, which may be referred to as a “pore size distribution plot”. BET surface analysis of a microporous and/or mesoporous PDC material will result in a pore size distribution plot which shows that micropores and/or mesopores contribute to a specific surface area of the material. Similarly, mercury porosimetry analysis of a macroporous PDC material will result in a pore size distribution plot which shows that macropores contribute to a specific surface area of the material. The area under the curve is representative of the total specific surface area of the material provided by those pore sizes. Together, BET surface analyses and mercury porosimetry may provide the total specific surface area. Micropores may contribute at least about 5%, 10%, 20%, 30%, 40%, 50%, 60% or even 70% specific surface area to one or both of the BET specific surface area and total specific surface area of a PDC material of the present invention. For example, the pore size distribution plot of FIG. 3 shows that micropores contribute at least about 20% specific surface area to the BET specific surface area of the PDC material of Example 1. As otherwise generally used herein, and unless context indicates otherwise, the specific surface area refers to the total specific surface area of a porous PDC material as described herein, which has micropores, mesopores and/or macropores.

Porosity may be classified as high, medium and low. “High porosity” refers to a specific surface area which is greater than or equal to 70 m²/g. “Medium porosity” refers to a specific surface area which is between 40 and 70 m²/g. “Low porosity” refers to a specific surface area which is less or equal to 40 m²/g. It is generally expected that a PDC material containing macropores only will have a specific surface area not exceeding 50 m²/g, which is of medium porosity. For example, a PDC produced using phase-separating resins would be expected to give rise to a PDC material with a specific surface area not exceeding 50 m²/g. In some embodiments, the present invention provides for PDC materials of high porosity, and even with a specific surface area of greater than even 100 m²/g which may be described as “very high porosity”. The present invention also provides PDC materials with a specific surface area of greater than 130, 150, 200, 300, 400 and even upwards of 500 m²/g. Accordingly, in certain preferred embodiments, the porous PDC material is characterised by a high or very high porosity, with a specific surface area of greater than or equal to 70, 80, 90 or even 100 m²/g, or in some embodiments even greater than 130, 150, 200, 300, 400 and even 500 m²/g. Further, in certain embodiments, the porous PDC material is characterised by a high or very high porosity when analysed by BET surface analysis alone. That is, in certain embodiments, the porous PDC material is characterised by a high or very high BET specific surface area, and in other words a high or very high combined micro- and meso-porosity.

The resins of the present invention find particular utility in forming manufactured PDC material articles from shaped preceramic polymer articles (also known as “green bodies”). Green bodies may be formed by shaping processes known in the art. Particularly applicable to the present invention are injection moulding methods such as liquid silicone rubber injection moulding, and 3D printing methods such as stereolithography, digital light projection, two-photon lithography and continuous liquid interface methods, and direct ink writing. The articles produced may find use in numerous engineering and scientific fields in which ceramic materials are employed, and because the PDC materials are porous this opens the PDC materials to utility in new applications such as those using membranes and chromatography.

### Porous Ceramic Particles

Pores may be formed in a PDC material by the inclusion of porous ceramic particles in the preceramic resin. This gives rise to an advantage of the present invention, as it allows the introduction of pores of sizes that may not otherwise be present or formable in a PDC material. It also enables enhanced control over or “tuning” of the porosity of the PDC ceramic material based on the selection of particles with specific pore sizes. For example, micropores may be introduced to a PDC material by the use of microporous ceramic particles. Similarly, micropores and/or mesopores may be introduced to a PDC material by the use of mesoporous ceramic particles (micropores may be formed from mesoporous ceramic particles by pore shrinkage during pyrolysis—for example, mesopores of diameter 2-3 nm may become micropores of diameter 1-2 nm during pyrolysis). This aids to open the PDC materials to utility in new applications requiring specific pore size or porosity. The use of particles can also imbue strength to a PDC material.

Accordingly, in certain preferred embodiments, the preceramic resin comprises a first functionalised organosilicon monomer having a first ceramic yield and porous ceramic particles, optionally together with one or all of a second functionalised organosilicon monomer having a second ceramic yield, a functionalised organic monomer and a porogen.

As the PDC materials are based on organosilicon monomers which form silicon-based ceramic materials following pyrolysis (as explained further below), then preferably the porous ceramic particles are also formed from a silicon ceramic material. Examples of silicon ceramic materials from which porous ceramic particles may be made include SiO₂, Si₃N₄, SiC, SiCN, SiCO, SiCNO, SiBCN, SiBCO, SiAlCN, and SiAlCO. These forms of porous ceramic particles may be described as silicon ceramic particles. In preferred embodiments, the porous ceramic particles are silica (SiO₂) particles.

The porous ceramic particles may be of any size fit for purpose. For example, particle sizes of up to 1 mm are useable with many 3D printing methods, while particle sizes of up to several millimetres are useable with many injection moulding methods.

In some embodiments, the ceramic particles are microparticles. By “microparticles” is meant a plurality of particles having a particle size falling between 1 μm and 1 mm. Preferably, the microparticles have a size falling between 1 μm and 500 μm, between 1 μm and 200 μm, between 1 μm and 100 μm, and between 1 μm and 50 μm. It is common for particulate materials to be supplied with a specified particle size range which usually reflects that at least a majority portion of those particles have a size within that range. This may be described as a particle size distribution. The particles may be predominantly within that particle size range (e.g. >95%, >99%) or entirely within the particle size range. In some embodiments, at least 90%, 95%, 98%, 99%, 99.5% and even 99.9% of the ceramic microparticles included in the resin have a size of between about 1 μm and 200 μm, between about 1 μm and 100 μm, or between about 1 μm and 50 μm. In other embodiments, the porous ceramic particles are nanoparticles. By “nanoparticles” is meant a plurality of particles having a particle size falling under 1 μm. Preferably, the nanoparticles have a size falling under 500 nm, under 200 nm and preferably under 100 nm, even under 50 nm. In preferred embodiments, at least 90%, 95%, 98%, 99%, 99.5% and even 99.9% of the porous ceramic nanoparticles included in the resin have a size of between about 1 nm to about 100 nm, preferably between about 1 nm and 50 nm, and more preferably between about 5 nm and 20 nm. In some embodiments, the ceramic particles include both microparticles and nanoparticles, in which case the preceramic resin may be said to comprise ceramic particles wherein a plurality of particles have a particle size falling under 1 mm. Preferably, the ceramic particles have a size falling under 500 μm, under 200 μm, under 100 μm, or under 50 μm. In preferred embodiments, at least 90%, 95%, 98%, 99%, 99.5% and even 99.9% of the ceramic particles included in the resin have a size of between about 1 nm and 1 mm, between about 1 nm and 500 μm, between about 1 nm and 200 μm, between about 1 nm and 100 μm, or between about 1 nm and 50 μm. Methods for determining particle size and particle size distribution are known in the art and include small angle X-ray scattering, dynamic light scattering and transmission electron microscopy. Preferably, the particles size distribution is determined using transmission electron microscopy (TEM).

While the porous ceramic particles may contain pores of varying sizes, in preferred embodiments the porous ceramic particles are microporous and/or mesoporous. This is at least in part because there are other ways of introducing meso- and macro-pores to PDC materials, as outlined below. The use of microporous (and in some instances mesoporous) ceramic particles allows for the introduction of micropores which may not otherwise be formable, and therefrom the production of microporous PDC materials and even hierarchically porous PDC materials; that is, a PDC material containing micro-, meso and macropores.

When porous ceramic particles are present, they may be present in the preceramic resin in an amount of at least about 0.5%, 1%, 2%, 5%, 8%, 10% or at least about 15% by weight of the preceramic resin. When present, the amount of the porous ceramic particles is preferably not more than about 95%, 90%, 70%, 50%, 30%, or not more than about 25% by weight of the preceramic resin. The amount of the porous ceramic particles by weight of the preceramic resin may be influenced by the size and density of the particles and as such can be included in the preceramic resin on a volume basis, in which case the porous ceramic particles may be present in the preceramic resin in an amount of at least about 0.1%, 0.5%, 1%, 2%, 5%, 8% or at least about 10% by volume of the preceramic resin. The amount of the porous ceramic particles may be not more than about 98%, 95%, 90%, 80% or not more than about 70% by volume of the preceramic resin. Any minimum and maximum can be combined without restriction. For example, the amount may be between 0.5% and 95% by weight of the preceramic resin, between 0.5% and 25% by weight of the preceramic resin, between about 0.1% and 98% by volume of the preceramic resin or between 0.1% and 70% by volume of the preceramic resin, etc. In the case of micro- and mesoporous nanoparticles for example, an amount of between about 1 wt % to about 30 wt %, preferably between about 2 wt % to about 25 wt %, more preferably between about 2 wt % to about 20 wt %, of the preceramic resin, has been found to provide PDC materials containing micropores which contribute to a porosity which is useful in the applications described above. Porous ceramic particles are determinable as micro-, meso- and/or macroporous using the same BET surface analysis and/or mercury porosimetry analysis as described above.

### Monomers

As described herein, a preceramic resin may comprise one or both of a (i) a second functionalised organosilicon monomer and (ii) a functionalised organic monomer, in addition to the first functionalised organosilicon monomer. Monomers (i) and/or (ii) may be collectively referred to as the “second functionalised monomer(s)”. Therefore, along with a first functionalised organosilicon monomer, the preceramic resin may comprise a second functionalised monomer being one or both of a second functionalised organosilicon monomer having a second ceramic yield, and a functionalised organic monomer.

In certain preferred embodiments, the preceramic resin comprises one of the following combinations:
a) a first functionalised organosilicon monomer having a first ceramic yield and a second functionalised organosilicon monomer having a second ceramic yield;
b) a first functionalised organosilicon monomer having a first ceramic yield and a functionalised organic monomer;
c) a first functionalised organosilicon monomer having a first ceramic yield, a second functionalised organosilicon monomer having a second ceramic yield, and porous ceramic particles; and
d) a first functionalised organosilicon monomer having a first ceramic yield, a functionalised organic monomer, and porous ceramic particles.

In certain preferred embodiments, the preceramic resin comprises a first functionalised organosilicon monomer having a first ceramic yield and a second functionalised organosilicon monomer having a second ceramic yield, optionally together with one or both of porous ceramic particles and a porogen.

By a first functionalised organosilicon monomer having a “first ceramic yield” and a second functionalised organosilicon monomer having a “second ceramic yield” is meant as distinct from each other. That is, a first functionalised organosilicon monomer having a first ceramic yield is a monomer with a different ceramic yield to that of a second functionalised organosilicon monomer having a second ceramic yield.

An advantage of the present invention arises from the presence of first and second organosilicon monomers having first and second ceramic yields. It has been found that this enables the formation of mesopores and macropores. It also enables the formation of micropores in the PDC materials, although this occurs to a lesser extent. Without wishing to be limited by theory, it is believed that organosilicon monomers with different ceramic yields undergo different degrees of linear shrinkage under pyrolytic conditions which results in the formation of these pores in the structure of the resulting PDC material. This enables “tuning” of the porosity of the PDC material by using first and second organosilicon monomers with marginally to widely differing ceramic yields (and optionally in combination with porous ceramic particles). For example, using a preceramic resin comprising first and second organosilicon monomers with ceramic yields that differ by about 30% or more tends to result in PDC materials with higher porosity as compared to a preceramic resin comprising first and second organosilicon monomers with ceramic yields that differ by less than 30%, and especially that differ by about 5% or less. Thus, PDC materials are obtainable with a tuned porosity. Of course, this is compounded when used in combination with porous ceramic particles and the advantage thereof described above. The same advantage arises from the use of a first organosilicon monomer having a first ceramic yield and a second functionalised monomer being a functionalised organic monomer. It has been found that this also enables the formation of mesopores and macropores and (to a lesser extent) micropores in the PDC materials, even if giving rise to less overall porosity as compared with the use of a second organosilicon monomer. Without wishing to be limited by theory, it is believed that a functionalised organic monomer may crosslink with an organosilicon monomer in a random molecular pattern causing different molecules and/or areas of molecules of the organosilicon monomer to undergo different degrees of linear shrinkage under pyrolytic conditions resulting in the formation of pores in the structure of the resulting PDC material. This enables “tuning” of the porosity of the PDC material by using different functionalised organic monomers in different amounts which form different crosslinked structures. Thus, PDC materials are obtainable with a tuned porosity. Of course, this is compounded when used in combination with porous ceramic particles and the advantage thereof described below.

Together, the monomers, including the first functionalised organosilicon monomer with one or both of the second functionalised organosilicon monomer and the functionalised organic monomer, may be present in a combined amount of at least about 30%, 40%, 50%, 60% or at least about 70% by weight of the preceramic resin and up to an amount of about 98%, 95%, 90%, or about 80% by weight of the preceramic resin. The monomers may also be present in the preceramic resin in an amount of at least about 10%, 15%, 20%, 25% or at least about 30% by volume of the preceramic resin. The amount of the monomers may be not more than about 95%, 90%, 80%, 75% or not more than about 70% by volume of the preceramic resin. Any minimum and maximum can be combined without restriction. For example, the amount may be between 30% and 98% by weight of the preceramic resin, between 30% and 80% by weight of the composition etc. In preferred embodiments the monomers may together be present in an amount of at least about 60 wt % to about 90 wt %, preferably between about 65 wt % to about 85 wt %, and more preferably between about 70 wt % to about 80 wt % of the preceramic resin.

### Organosilicon Monomers

An organosilicon preceramic monomer is characterisable by a ceramic yield. A “ceramic yield” refers to the mass of PDC material obtainable by pyrolysis, expressed as a percentage of the mass of the preceramic monomer (i.e. the mass of the converted PDC material as a percentage of the preceramic material). For example, an organosilicon preceramic monomer when 10 g of PDC material is formed by pyrolysis of 11 g of preceramic monomer has a ceramic yield of 10/11*100-91%.

The ceramic yield of an organosilicon preceramic monomer is a chemical property generally influenced by the chemical structure of the monomer. Methods for determining the ceramic yield of an organosilicon preceramic monomer are known in the art and generally involve subjecting the monomer to pyrolysing conditions in a thermogravimetric analyser (TGA). Generally, in TGA the weight of a monomer is measured during pyrolysis as it undergoes conversion to a PDC material. The maximum pyrolysis temperature is usually at least about 600° C. and is often about 850° C. to ensure complete conversion to PDC material. Complete conversion is generally indicated by an experimentally-determined zero weight change between time points. A TGA may be capable of determining a starting weight and a final weight following pyrolysis, and from this the ceramic yield can be calculated. A detailed methodology is provided in the Examples. In preferred embodiments, ceramic yield is determined using this method, which may herein be referred to as “TGA₈₅₀ ceramic yield” or “TGA₈₅₀ method”, “850” representing the maximum temperature reached during the analysis.

An “organosilicon” is a chemical compound with a chemical structure that contains silicon atoms covalently bonded to carbon atoms. Preceramic organosilicon monomers are generally based on a long-chain backbone structure of repeating silicon atom-containing motifs, and in that sense they are generally polymeric materials themselves. Examples applicable to the present invention include polysiloxanes, polycarbosiloxanes, polysilsesquioxanes, polycarbosilanes, polysilylcarbodiimides, polysilsesquicarbodiimides, polysilazanes, polysilsesquiazanes, polyborosilanes, polyborosiloxanes and polyborosilazanes. As silicon and carbon atoms are generally tetravalent, an organosilicon, including the backbone structure of polymeric monomers, is generally substituted with carbon-containing organic chemical groups. By “substituted” in reference to an organosilicon is meant that any one or more hydrogen atoms bound to an atom under consideration is replaced, provided that the atom's valence is not exceeded and a stable compound results. Non-limiting examples of suitable substituents include those of the R-groups as defined below.

The organosilicon preceramic monomers used in the preceramic resins are polymerisable and as such they may be said to be “functionalised”, meaning that they contain a polymerisable functional group. The polymerisable functional group may be substituted at one or more points of the organosilicon including, in the case of polymeric organosilicon monomers, at any point(s) along the backbone structure. Alternatively, or in addition, and especially in the case of polymeric organosilicon monomers, the polymerisable functional group may be terminally substituted, i.e. at one or more end groups of the backbone structure. By “substituted” in reference to a functionalised organosilicon is meant that any one or more non-polymerisable chemical groups bound to an atom under consideration is replaced by a polymerisable functional group, provided that the atom's valence is not exceeded and a stable compound results. Non-limiting examples of suitable substituents include those of the polymerisable functional groups as defined below.

Turning first to the identity of the organosilicon monomer before it is functionalised, in preferred embodiments the first organosilicon monomer is selected from one or more of a polysiloxanes, polycarbosiloxanes, polycarbosilanes, polysilylcarbodiimides and a polysilazane. These may have the following chemical structures of Formula 1, Formula 2, Formula 3, Formula 4 and Formula 5, respectively:

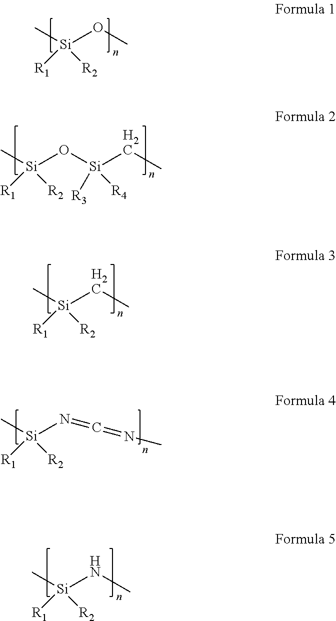

wherein:
n represents a backbone structure of repeating silicon atom-containing motifs and is independently an integer of from 2 to 15; and
R₁, R₂, R₃ and R₄ are independently selected from the group consisting of H, a C₁-C₁₈ substituted or unsubstituted alkyl, a C₁-C₁₈ substituted or unsubstituted alkyl ether, a phenyl and a halide, independently for each integer of n, with the proviso that the pairs of R₁ and R₂ and R₃ and R₄ are not both H, alkyl ether or halide for every integer of n. Preferably, the pairs of R₁ and R₂ and R₃ and R₄ are not both H, alkyl ether or halide for any integer of n. Preferably, each of R₁ and R₂ and R₃ and R₄ are identical for every integer of n.

In formulas 2, 3 and 5, the hydrogen atoms of the CH₂ and NH groups may also be substituted with one or more groups as defined for R₁. As stated above, an organosilicon is a chemical compound with a chemical structure that contains silicon atoms covalently bonded to carbon atoms, which includes organosilicon monomers of formulas 1 to 5 where n is an integer equal to 1. That is, in formulas 1 to 5, n may independently be an integer of 1 or more, or from 1 to 15.

The first organosilicon monomer may also be a polyoctahedral silsesquioxane. The first organosilicon monomer may be selected from one or more of a polysilsesquioxanes, polysilsesquicarbodiimides and a polysilsesquiazanes substituted with one or more groups as defined for R₁.

In alternative embodiments, the first organosilicon monomer is selected from one or more of a polyborosilane, a polyborosiloxane and a polyborosilazane. These may have the chemical structures of Formula 6, Formula 7 and Formula 8:

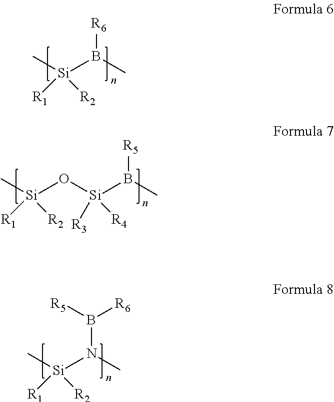

wherein:
n represents a backbone structure of repeating silicon atom-containing motifs and is independently an integer of from 2 to 15;
R₁, R₂, R₃ and R₄ are as defined above; and
R₅ and R₆ are independently selected from the group consisting of H, OH, a C₁-C₁₈ substituted or unsubstituted alkyl, a C₁-C₁₈ substituted or unsubstituted alkyl ether and a phenyl, independently for each integer of n. Like for R₁, R₂, R₃ and R₄, preferably R₅ and R₆ are identical for every integer of n.

In more preferred embodiments, the first organosilicon monomer is selected from one or more of a polysiloxane, polycarbosiloxane and a polycarbosilane wherein n is independently an integer of from 3 to 5 and R₁, R₂, R₃ and R₄ are identical for every integer of n and independently selected from the group consisting of H, methyl and isobutyl, with the proviso that the pairs of R₁ and R₂ and R₃ and R₄ are not both H, and a polysilsesquioxane substituted with a group as defined for R₁ and preferably isobutyl.

As stated above, an organosilicon is a chemical compound with a chemical structure that contains silicon atoms covalently bonded to carbon atoms, which includes organosilicon monomers of formulas 6 to 8 where n is an integer equal to 1. That is, in formulas 6 to 8, n may independently be an integer of 1 or more, or from 1 to 15.

Turning now to the identity of the functionalised organosilicon monomer, the first functionalised organosilicon monomer may be obtained by substituting any one or more of R₁, R₂, R₃ and R₄, or a terminal group(s) of the monomer, with one or more of one or more types of polymerisable functional groups. Polymerisable group of different “types” are those having different chemical structures. The type of functional group(s) used is not particularly critical provided that they provide for polymerization of the monomer(s).

In resins with a first but not a second functionalised organosilicon monomer, one type of polymerisable functional group may be used, selected such that it reacts with itself, or alternatively two or more types may be used, selected such that they react with (i.e. are complementary to) each other. In each case, the preceramic resin may optionally further comprise a crosslinking agent in order to crosslink the monomers of the resin via a crosslinker group.

In preferred embodiments, because the resins of the invention find particular utility in forming shaped preceramic polymer articles by 3D printing and injection moulding methods which often rely on thermal- and/or photopolymerization, the polymerisable functional group is compatible and as such is thermal- or photopolymerisable. In which case, the polymerisable functional group(s) are preferably selected from a group, or a group containing a motif, selected from one or more of an ester, amine, hydroxyl, epoxide, vinyl, allyl, ethynyl, thiol, glycidyl, isocyanurate, alkacrylate, cyano, cyanate and thiocyanate. In preferred embodiments, the first functionalised organosilicon monomer contains one polymerisable functional group type, and is preferably an allyl, a vinyl, a thiol or an acrylate.

In preferred embodiments, the first functionalised organosilicon monomer is a polysiloxane, a polysilsesquioxane, a polycarbosilane or a polycarbosilazane selected from methacryloxypropyl terminated polydimethylsiloxane, vinylmethoxysiloxane homopolymer, methacryloxypropyl substituted poly(isobutyl-t8-silsesquioxane), allylhydrydopolycarbosilane and methylvinylhydrogen polycarbosilazane.

The first functionalised organosilicon monomer may be present in an amount of at least about 15%, 20%, 25%, 30% or at least about 35% by weight of the preceramic resin and up to an amount of about 98%, 95%, 90%, or about 80% by weight of the preceramic resin. The first functionalised organosilicon monomer may also be present in the preceramic resin in an amount of at least about 10%, 15%, 20%, 25% or at least about 30% by volume of the preceramic resin. The amount of the first functionalised organosilicon monomer may be not more than about 95%, 90%, 80%, 75% or not more than about 70% by volume of the preceramic resin. Any minimum and maximum can be combined without restriction. For example, the amount may be between 15% and 98% by weight of the preceramic resin, between 15% and 80% by weight of the composition etc. In embodiments with a first but not a second functionalised organosilicon monomer, the first functionalised organosilicon monomer may preferably be present in an amount of at least about 60 wt % to about 90 wt %, preferably between about 65 wt % to about 85 wt %, and more preferably between about 70 wt % to about 80 wt %.

The second functionalised organosilicon monomer is selected from the classes of functionalised organosilicon monomer as described above for the first functionalised organosilicon monomer, but will have a different ceramic yield. Nevertheless, the broad classes and functional groups from which the second functionalised organosilicon monomer will be selected, including the polymerisable functional groups, are as described above for the first functionalised organosilicon monomer. This includes in respect of the preferred features. Generally, to ensure a different ceramic yield, the second functionalised organosilicon monomer will have a different chemical structure to that of the first functionalised organosilicon monomer, whether that be by way of the backbone or polymerisable functional group.

In preferred embodiments, the second functionalised organosilicon monomer is selected from the group consisting of polysiloxanes, polycarbosiloxanes, polysilsesquioxanes, polycarbosilanes, polysilylcarbodiimides, polysilsesquicarbodiimides, polysilazanes, polysilsesquiazanes, polyborosilanes, polyborosiloxanes and polyborosilazanes, each of which is substituted with one or more polymerisable functional groups selected from a group, or a group containing a motif, selected from one or more of an ester, amine, hydroxyl, epoxide, vinyl, allyl, ethynyl, thiol, glycidyl, isocyanurate, alkacrylate, cyano, cyanate and thiocyanate; with the proviso that the second functionalised organosilicon monomer has a different ceramic yield to that of the first functionalised organosilicon monomer. The second functionalised organosilicon monomer may therefore have a structure of Formula 1, Formula 2, Formula 3, Formula 4, Formula 5, Formula 6, Formula 7 or Formula 8, or may be a polysilsesquioxanes, polysilsesquicarbodiimides and a polysilsesquiazanes as defined above, each of which is substituted with one or more polymerisable functional groups selected from a group, or a group containing a motif, selected from one or more of, an ester, amine, hydroxyl, epoxide, vinyl, allyl, ethynyl, thiol, glycidyl, isocyanurate, alkacrylate, cyano, cyanate and thiocyanate, with the proviso that the second functionalised organosilicon monomer has a different ceramic yield to that of the first functionalised organosilicon monomer. In each instance, the polymerizable functional group is preferably one or more of a vinyl, allyl, thiol and an acrylate.

In certain preferred embodiments, the second organosilicon monomer is a polyoctahedral silsesquioxane. The polyoctahedral silsesquioxane is preferably selected from one or more of a polysilsesquioxanes, polysilsesquicarbodiimides and a polysilsesquiazanes. An added advantage is arising from the use of polyoctahedral silsesquioxane, as it has been found that they tend to result in larger pores, even tending towards the macropore size range, thereby increasing the degree of available “tuning” of the porosity of the PDC materials.

The second functionalised organosilicon monomer may contain a polymerisable functional group that is different from, though complementary to, the polymerisable functional group of the first functionalised organosilicon monomer, such that under polymerising conditions the first and second polymerisable functional groups react, optionally via a crosslinker group, and crosslink the monomers together. Alternatively, the second functionalised organosilicon monomer may contain a polymerisable functional group that is the same as the polymerisable functional group of the first functionalised organosilicon monomer, such that under polymerising conditions the first and second polymerisable functional groups react with each other, optionally by a crosslinking agent, to crosslink the monomers together.

Crosslinking agents containing crosslinker groups may be included in the preceramic resin. Crosslinking agents are generally chemical compounds which may be said to be functionalised in that they include at least two or more functional groups as described above in respect of, and complementary to, the polymerisable functional groups of any one or all of the functionalised organosilicon monomer(s) included in the preceramic resin. The functional groups of a crosslinking agent react with polymerisable functional groups of functionalised organosilicon monomer(s) resulting in a crosslinker group in the structure of the preceramic polymer. Example crosslinking agents include functionalised silane monomers or oligomers, diacrylates and dithiols among others. When present, a crosslinking agent having crosslinker groups will be selected based on the polymerisable functional groups of the functionalised organosilicon monomer(s). Crosslinking groups may therefore be selected from the polymerisable functional groups described above in respect of the first and second functionalised organosilicon monomers, including in preferred embodiments selected from one or more of a vinyl, allyl, thiol and an acrylate.

Exemplary pairs of first and second functionalised organosilicon monomers and crosslinking agents are presented in Tables 1 and 2 below.

In resins with a first and a second functionalised organosilicon monomer, the monomers are preferably present in stoichiometric amounts equating to complete, or as near as possible complete, reactivity of the polymerisable functional groups. That is, the first and a second functionalised organosilicon monomers are preferably present in a 1:1 ratio in respect of the polymerisable functional groups.

Within this preferred parameter, the amount of the second functionalised organosilicon monomer, when present in the preceramic resin, may be present in in an amount of at least about 15%, 20%, 25%, 30% or at least about 35% by weight of the preceramic resin and up to an amount of about 80%, 75%, 70%, or about 65% by weight of the preceramic resin. The second functionalised organosilicon monomer may also be present in the preceramic resin in an amount of at least about 5%, 10%, 15%, 20% or at least about 25% by volume of the preceramic resin. The amount of the second functionalised organosilicon monomer may be not more than about 75%, 70%, 65%, 60% or not more than about 55% by volume of the preceramic resin. Any minimum and maximum can be combined without restriction. For example, the amount may be between 15% and 80% by weight of the preceramic resin, between 15% and 65% by weight of the composition etc.

### Organic Monomers

An “organic monomer” is a carbon-containing chemical compound and is other than the organosilicon monomers as described herein. The organic monomer is typically a silicon-free organic monomer. Organic compounds tend to contain covalent carbon-carbon bonds and carbon-hydrogen bonds, and often contain covalently-bonded heteroatoms such as oxygen and nitrogen. Organic compounds are identifiable to those of skill in the art. A “functionalised” organic monomer is one which contains two or more reactive functional groups each of which are reactive with at least the first functionalised organosilicon monomer to form crosslinks. This may be by crosslinking with the organosilicon monomer functional groups. The functional groups of the functionalised organic monomer may thus be referred to as polymerisable functional groups. The portion of chemical structure between the reactive groups may be referred to as a “spacer”. A functionalised organic monomer may thus be represented by the following formula:

Spacer(L)ₙ
wherein Spacer is a spacer group, L is a reactive group reactive with at least the first functionalised organosilicon monomer, and n is an integer of greater than or equal to 2. In preferred embodiments, n is an integer of from 2 to 4, and is preferably 2.

The spacer group may be based on a short- or long-chain, optionally branched, backbone structure including for example ethylene, ethylene glycol, polyethylene, polyethylene glycol propylene, polypropylene glycol, polypropylene, polyproypylene glycol, ethylamine, polyethyleneimine, propylamine, polypropyleneimine etc. By “substituted” in reference to an organic monomer is meant that any one or more atoms or chemical groups pendant to an atom of the backbone chain is replaced, provided that the atom's valence is not exceeded and a stable compound results. The reactive group may be substituted at any point(s) of the backbone chain, and are preferably terminally substituted, i.e. at two end groups of the backbone structure. The at least two reactive groups may be the same or different depending on the desired crosslinking with the first functionalised organosilicon monomer. The two or more reactive groups are preferably the same. The reactive group is preferably selected from a group, or a group containing a motif, selected from one or more of an ester, amine, hydroxyl, epoxide, vinyl, allyl, ethynyl, thiol, glycidyl, isocyanurate, alkacrylate, cyano, cyanate and thiocyanate. In preferred embodiments, the reactive group is an allyl, a vinyl, a thiol or an acrylate.

Representative preferred functionalised organic monomers include ethylene glycol diacrylate, poly ethylene glycol diacrylate, ethylene glycol dithiol, polyethylene glycol dithiol, ethylene glycol divinyl ether, polyethylene glycol divinyl ether, ethylene glycol diallyl ether, and polyethylene glycol diallyl ether.

The crosslinking agents described above may also constitute functionalised organic monomers.

An advantage of the use of a functionalised organic monomer is that they tend to be more reactive under polymerising conditions than functionalised organosilicon monomers and can assist to increase the rate of polymerisation and extent of crosslinking giving further tuning capabilities in terms of porosity formed in the polymer-derived ceramic material.

In resins with a first functionalised organosilicon monomer and a functionalised organic monomer, and optionally a second functionalised organic monomer, the monomers are preferably present in stoichiometric amounts equating to complete, or as near as possible complete, reactivity of the polymerisable functional groups. That is, the first functionalised organosilicon monomer and organosilicon monomer may be present in a 1:1 ratio in respect of the polymerisable functional groups. When a second functionalised organosilicon monomer is present, the ratio may be 1:0.5:0.5, 1:0.2:0.8, 1:0.7:0.3 etc., in any particular order. Within this preferred parameter, the amount of the functionalised organic monomer, when present in the preceramic resin, may be present in in an amount of at least about 1%, 2%, 5%, 8% or 10%, 15%, 20%, 25%, 30% or at least about 35% by weight of the preceramic resin and up to an amount of about 80%, 75%, 70%, or about 65% by weight of the preceramic resin. Any minimum and maximum can be combined without restriction. For example, the amount may be between 15% and 80% by weight of the preceramic resin, between 1% and 65% by weight of the composition etc.

### Porogens

A “porogen” is an organic compound added to a preceramic resin that is capable of escaping as a preceramic polymer is pyrolysed to form a PDC material. Without wishing to be limited by theory, it is thought that a porogen escape as gases during pyrolysis and, in escaping, leaves behind pores in the PDC material. The pores that are created by porogens are typically mesopores and/or macropores. This gives rise to an advantage of the present invention as it allows for the in situ introduction of pores to a PDC material and provides for enhanced control over the porosity of the resulting PDC material. That is, it enables “tuning” of the porosity of the PDC material.

Accordingly, in particular embodiments, the preceramic resin comprises a first functionalised organosilicon monomer having a first ceramic yield and a porogen, optionally together with one or more of a second functionalised organosilicon monomer with a second ceramic yield, a functionalised organic monomer, and porous ceramic particles. That is, in particular embodiments, the preceramic resin comprises one of the following combinations:
a) a first functionalised organosilicon monomer having a first ceramic yield and a porogen;
b) a first functionalised organosilicon monomer having a first ceramic yield, porous ceramic particles and a porogen;
c) a first functionalised organosilicon monomer having a first ceramic yield, a second functionalised organosilicon monomer having a second ceramic yield and/or a functionalised organic monomer, and a porogen; and
d) a first functionalised organosilicon monomer having a first ceramic yield, a second functionalised organosilicon monomer having a second ceramic yield and/or a functionalised organic monomer, porous ceramic particles and a porogen.

The size of the pores introduced to a PDC material by a porogen depend on the size of the porogen itself. That is, a meso porogen will tend to result in mesopores (and may also result in micropores) while a macro porogen will tend to result in macropores (and may also result in mesopores). Similarly, a combination of a meso porogen and a macro porogen will tend to result in a combination of mesopores and macropores.

Examples of preferred meso porogens include toluene, methanol, cyclohexanol, hexane, dodecanol, 1,2-popanediol, water, 1-propanol, 1,4-butandiol, dimethylformamide, acetonitrile, decane and decanol, while example of preferred macro porogens include polyethylene glycol (PEG) such as PEG 200, PEG 400, and PEG 20,000, and polyethylene glycol diacrylate (PEGDA) such as PEGDA 250 and PEGDA 575. In preferred embodiments the meso porogen is toluene and the macro porogen is PEG 400.

The porogen may be present in an amount of at least about 0.5%, 1%, 2%, 5%, 7%, 10%, 15% or 20% by weight of the preceramic resin and up to an amount of about 35% 40%, 45%, 50% or 55% by weight of the preceramic resin. Any amount can be combined without restriction. For example, the amount may be between 0.5% and 20% by weight of the preceramic resin, between 1% and 10% by weight of the composition, between 20% and 50% by weight of the composition, 0.5% to 50% by weight of the composition etc. In some embodiments the porogen is present in an amount of from about 40% to 55%, or 45% to 55%, or 50% to 55%. In other embodiments, the porogen is present in an amount of from about 1% to about 10%, or 2% to 7% or about 5% by weight of the preceramic resin.

### Other Components

Various other components may be included in the resins of the present invention. This includes but is not limited to one or more of a free radical initiator, free radical inhibitor, photoblocker, 3D printing resolution agent, colour, surfactant, dispersants or emulsifier.

As explained above, because the resins of the invention find particular utility in forming shaped preceramic polymer and PDC articles using 3D printing and injection moulding processes, the polymerisable functional group of the organosilicon monomer(s) is preferably so-compatible and as such in many embodiments is thermal- or photopolymerisable. In which case, the resin may further comprise a free radical generator such as a thermal initiator or photoinitiator which in many instances form free radicals which catalyse the reaction of thermal- or photopolymerisable functional groups, respectively. When present, the thermal or photoinitiator may be present in an amount of between about 0.01 wt % to about 20 wt %, preferably between about 0.1 wt % to about 5 wt %, and more preferably between about 0.2 wt % to about 1 wt % of the preceramic resin.

Examples of thermal initiators include benzoyl peroxide, dicumyl peroxide and 2,2′-azobisisobutyronitrile.

Examples of photoinitiators include 2,2-dimethoxy-2-phenylacetophenone, 2-hydroxy-2-methylpropiophenone, camphorquinone, phenylbis(2,4,6-trimethylbenzoyl) phosphine oxide (BAPO), benzophenone and benzoyl peroxide.

In preferred embodiments, the free radical generator is a photoinitiator which forms free radicals under UV light (wavelength of about 100 to about 405 nm). The preferred example is phenylbis(2,4,6-trimethylbenzoyl) phosphine oxide.

When a free radical generator is included, the resin may also further comprise a free radical inhibitor (also known as a free radical scavenger). Examples include hydroquinone, methylhydroquinone, ethylhydroquinone, methoxyhydroquinone, ethoxyhydroquinone, monomethylether hydroquinone, propylhydroquinone, propoxyhydroquinone, tert-butylhydroquinone (TBHQ) and n-butylhydroquinone. In preferred embodiments the free radical inhibitor is tert-butylhydroquinone. When present, the free radical inhibitor may be present in an amount of about 0.01 wt % to about 20 wt %, preferably between about 0.05 wt % to about 5 wt %, and more preferably between about 0.1 wt % to about 2 wt % of the preceramic resin.

Examples of photoblockers (also known as photoblockers) include 2,5-Bis(5-tert-butyl-benzoxazol-2-yl)thiophene (BBOT), 4,4′-bis(benzoxazolyl)-cis-stilbene and 4,4-diamino-2,2-stilbenedisulfonic acid. In preferred embodiments the photoblocker is BBOT. When present, a photoblocker may be present in an amount of between about 0.01 wt % to about 20 wt %, preferably between about 0.1 wt % to about 5 wt %, and more preferably between about 0.2 wt % to about 1 wt % of the preceramic resin.

Another component that may be included in the resins of the present invention is a third and subsequent functionalised organosilicon monomer. The third and subsequent functionalised organosilicon monomer may be selected in the same way and having the same identity and polymerisable functional groups as the first and second functionalised organosilicon monomers described above. The polymerisable functional groups of the third functionalised organosilicon monomer are selected for reactivity, optionally via a crosslinker group, with one or more of the polymerisable functional groups of the first and/or second functionalised organosilicon monomers. It is not necessary that the third and subsequent functionalised organosilicon monomer has a different ceramic yield to the first and/or second. However, if it does have a (third) ceramic yield that is different to the first and second ceramic yields, this may further contribute to the formation of pores in the PDC material.

When present, the third and subsequent functionalised organosilicon monomer is preferably a polysiloxane, a polysilsesquioxane, a polycarbosilane or a polycarbosilazane. The third (or subsequent) functionalised organosilicon monomer may be selected from one or more of methacryloxypropyl terminated polydimethylsiloxane, vinylmethoxysiloxane homopolymer, methacryloxypropyl substituted poly(isobutyl-t8-silsesquioxane), allylhydrydopolycarbosilane and methylvinylhydrogen polycarbosilazane. When present, the third and subsequent functionalised organosilicon monomer may be present in an amount of about 1 wt % to about 50 wt %, preferably between about 5 wt % to about 30 wt %, and more preferably between about 10 wt % to about 20 wt % of the preceramic resin.

Another component that may be included in the resins of the present invention is a second and subsequent functionalised organic monomer as described above.

### Methods of the Invention

Methods of the present invention involve subjecting a preceramic resin to polymerising conditions to form a preceramic polymer, and pyrolysing the preceramic polymer to form a PDC material.

“Polymerising conditions” are conditions under which polymerisation reactions occur. A number of polymerisation reaction chemistries are applicable including but not limited to step-growth polymerisation including condensation reactions, and chain-growth polymerisation including cationic or anionic addition reactions or thermal- or photo-catalysed free radical reactions. The polymerising conditions selected will depend on the polymerisable functional groups of the functionalised organosilicon monomer(s), and are intended to crosslink the monomers together.

As described above, the resins of the invention find particular utility in forming shaped preceramic polymer and PDC material articles using 3D printing and injection moulding processes, and so the polymerisable functional groups are so-compatible, preferably being photopolymerisable. Thus, in preferred embodiments the polymerising conditions include the presence of other components in the preceramic resin which aid photopolymerisation, as described above.

“Pyrolysis” is the thermally-induced conversion of the preceramic polymer from organic to inorganic (i.e. PDC) material. Similarly, “pyrolytic conditions” are conditions including elevated temperatures under which pyrolysis occurs. During pyrolysis, the inorganic material formed may exist in one or more material phases depending on the temperature to which the material is exposed; for example the inorganic material may proceed through an amorphous phase and then, as the temperature increases, transitions to a crystalline phase. The pyrolytic conditions used herein tend to result in amorphous polymer-derived ceramic materials, as the maximum temperature of pyrolysis tends to be lower than that which causes the transition from amorphous to crystalline phases. Similarly, when the preceramic resin contains components that are capable of forming pores during pyrolysis (e.g. preceramic resins as described herein), the amorphous phase may encompass a “porous phase” and a “non-porous phase”. The porous phase is characterised by the containing of pores, while the non-porous phase is other than the porous phase. The non-porous phase occurs at higher temperatures than the porous phase, and arises from the collapse of pores present in the porous phase. The temperature at which the porous phase ceases to exist and the non-porous phase comes into being may be referred to as the “porosity transition temperature”.

The temperatures range across which the porous and non-porous phases exist may differ depending on the composition of the preceramic resins. Generally speaking, the greater the number of components in a preceramic resin the higher the porosity transition temperature tends to be. For instance, a preceramic resin comprising a first functionalised organosilicon monomer, a second functionalised organosilicon resin, porous ceramic particles, a porogen a photoinitiator, free radical generator and a photoblocker may present with a higher porosity transition temperature than a preceramic resin not having one of these components; for example a preceramic resin comprising a first functionalised organosilicon monomer, a second functionalised organosilicon resin, porous ceramic particles, a photoinitiator, free radical generator and an photoblocker (i.e. absent of a porogen). In embodiments containing a greater number of components, the porosity transition temperature may be, for example, as high as about 1100° C. Expressed another way, the maximum temperature of pyrolysis may be 1100° C. By “maximum temperature” is meant that the maximum temperature reached during pyrolysis does not exceed the given “maximum temperature” value. That said, generally speaking the porous phase may occur at less than 1000° C. and often within the range of about 300° C. and 900° C. For instance, in embodiments in which the porous phase ceases to exist at 900° C., then 900° C. is taken to be the porosity transition temperature. Whether or not a PDC material has been formed by pyrolysis with a maximum temperature of below the porosity transition temperature, or within the porous phase, is determinable by measuring the porosity of the formed material, for example using BET surface analysis as described herein. The porosity transition temperature is similarly determinable by, for example, analysing the porosity of PDC materials formed at different temperatures. Accordingly, porous PDC materials may be produced by controlling the temperature of pyrolysis; a porous PDC material may be produced by not exceeding the porosity transition temperature. Or in other words, a porous PDC material may be produced by pyrolytic conditions characterised by a maximum temperature within the porous phase, or in other words by pyrolytic conditions characterised by a maximum temperature of less than the porosity transition temperature.

The pyrolytic conditions characterised by a maximum temperature within the porous phase, which may be no greater than about 1000° C., gives rise to a particular advantage of the present invention Usually PDC materials are formed using pyrolytic conditions with temperatures above what may correspond to a porosity transition temperature, or for example of well over 1000° C. It has been found that while these high temperatures induce the necessary organic to inorganic conversion of the preceramic polymers to form PDC materials, high temperatures result in solid PDC materials essentially absent of porous character. It has been found that temperatures much cooler, within what may correspond to a porous phase, or under what may correspond to a porosity transition temperature, which may be for example less than 1000° C., are suitable to induce the organic to inorganic conversion, with the added benefit of forming and/or maintaining porous structure. Temperatures even in the area of a maximum temperature no greater than about 950° C., 900° C., 850° C., 800° C., 750° C., 700° C., 650° C. and even 600° C. may also be suitable to induce the organic to inorganic conversion while forming and/or maintaining porous structure, and often tending towards greatest porosity at the lower end of this range, for example of 700° C. or less. The relevant temperature will depend on the selected monomers (i.e. the first organosilicon monomer and, when present, the second organosilicon monomer and/or the functionalised organic monomer). Guidance on the relevant temperature can be obtained by TGA analysis of the monomer(s) and by review and comparison of the examples provided herein. A maximum pyrolysis temperature may be coupled with a minimum temperature of pyrolysis, still within the porous phase for the formation of pores. By “minimum temperature” is meant that the temperature during pyrolysis is increased to a value that rises above the given “minimum temperature”. In preferred embodiments, the minimum temperature may be as low as about 300° C. This minimum temperature is preferred for efficient conversion of organic to inorganic material and the initial appearance of porosity (which may be referred to as a “pore formation temperature”, pre-existing pores from the use of porous ceramic particles notwithstanding). Higher minimum temperatures are applicable for the same result and preferred for increasing porosity, including 325° C., 350° C., 375° C. 400° C. 425° C. or 500° C. Accordingly, expressed as a range, in preferred embodiments pyrolysis is performed between minimum and maximum temperatures of 300° C. and 900° C., 325° C. and 850° C., preferably 350° C. and 800° C., 375° C. and 750° C., and more preferably 400° C. and 700° C., and in some embodiments 425° C. and 650° C. or 450° C. and 600° C.

The particular PDC material produced will arise from the identity of the functionalised organosilicon monomer(s) and the selected porous ceramic particles (if present), and as such depend on the composition of the preceramic resin. The particular PDC material produced may also depend on the pyrolytic conditions used. In particular, pyrolysis may be performed in an inert or a reactive atmosphere. A reactive atmosphere is generally characterised by the presence of a reactive gas; that is, a gas that is, under pyrolytic conditions, reactive to at least one component of the preceramic polymer material. An inert atmosphere is generally characterised by the absence of a reactive gas. Examples of reactive gases include oxygen, carbon dioxide, water, (e.g. air) methane, ammonia and others. An example of an inert environment is an environment of nitrogen gas or under vacuum. The presence of a reactive environment will generally influence the nature of the gases which escape from the material during pyrolysis and thus the nature of the PDC material produced.

For example, pyrolysis of a polysiloxane organosilicon monomer in an inert atmosphere will generally produce silicon oxycarbide ceramic material whereas pyrolysis of a polysiloxane organosilicon monomer in a reactive air environment will generally produce silica ceramic material. This is because the gases in air undergo reactions with carbon atoms in the organosilicon backbone structure of the polysiloxane and escape as carbon-containing gases. Amorphous silica ceramic material is often referred to as “glass”.

Other PDC materials which may be produced depending on the preceramic polymer composition and pyrolytic conditions include Si₃N₄, SiC, SiCN, SiCO, SiCNO, SiBCN, SiBCO, SiAlCN, SiAlCO, SiON and/or SiBN.

In preferred embodiments, the pyrolytic conditions include an inert environment and a maximum temperature of about 600° C., while on other preferred embodiments the pyrolytic conditions include a reactive environment and a maximum temperature of about 700° C.

Methods of pyrolysis are otherwise known to persons skilled in the art. Generally speaking, a preceramic polymer material is placed in a cool furnace and the temperature is ramped up towards maximum at a specified rate(s), held for a period of time and ramped down again at a specified rate(s). Ramp rates may be selected based on the thermogravimetric profile of the organosilicon monomers used, as known to the person skilled in the art.

The rate of temperature increase during pyrolysis (which may be referred to as temperature “ramp-up”), and the time period of maintenance of the article at the maximum pyrolysis temperature, can be controlled to suit the creation and/or maintenance of the desired porous structure. In some examples, the rate of temperature increase is controlled to be suitably low (i.e. slow) for controlled pyrolysis. A ramp-up rate of no greater than 10° C./minute (or even slower as described below) is referred to as a “slow ramp-up rate”. A suitable rate of temperature increase for a period during the porous phase may be between 0.1° C./min and 10° C./min, for example between 0.1° C./min and 7° C./min, between 0.1° C./min and 5° C./min, between 0.2° C./min and 3° C./min, between 0.2° C./min and 2° C./min and preferably between 0.3° C./min and 1° C./min. In certain embodiments the ramp-up rate may be specifically about 0.3° C./min or about 1° C./min for a period within the porous phase. A slow ramp-up rate may be used for the entire period of the porous phase or may be used for a portion of the porous phase. In preferred embodiments, the slow temperature ramp-up rate is used for a period encompassing the pore formation temperature.

The duration of the period in which the slow ramp-up is used may differ depending on the ramp-up rate used, the pore formation temperature and the maximum pyrolysis temperature. The duration of the slow ramp-up rate may be expressed by reference to a time period. Generally, the duration of the period in which the slow ramp-up is used within the porous phase will be at least 30 minutes, preferably at least 1 hour. The period may be longer, for example at least 1.5 hours, 2 hours, 3 hours, 5 hours, 10 hours, 15 hours, 20 hours or longer. The time period may be up to 40 hours, 45 hours, 50 hours or 55 hours. Expressed as a range, the slow ramp-up rate may be used for a duration of from 1 hour to 55 hours, or 1.5 hours to 50 hours, or 2 hours to 45 hours, or 3 hours to 40 hours, or 15 hours to 40 hours, for example 20 to 25 hours. In preferred embodiments, the slow temperature ramp-up rate is used for the entire porous phase to the maximum pyrolysis temperature (i.e. from the pore formation temperature to the maximum pyrolysis temperature). For example, where the pore formation temperature is 300° C. and the maximum pyrolysis temperature is 700° C., the duration of the slow ramp-up rate period may be about 40 minutes (using a ramp-up rate of 10° C./minute), about 57 minutes (using a ramp-up rate of 7° C./minute), 1 hour 20 minutes (using a ramp-up rate of 5° C./minute), 2 hours 13 minutes (using a ramp-up rate of 3° C./minute), 3 hours 20 minutes (using a ramp-up rate of 2° C./minute), 6 hours 40 minutes (using a ramp-up rate of 1° C./minute), 13 hours 20 minutes (using a ramp-up rate of 0.5° C./minute) and 22 hours 13 minutes (using a ramp-up rate of 0.3° C./minute). For example a suitable rate of temperature increase between room temperature (about 20° C.) and 600° C. may be between 0.1° C./min and 2° C./min, and preferably between about 0.2° C./min and 1° C./min, while a suitable rate of temperature increase between 600° C. and 1000° C. may be between 1° C./min and 10° C./min, and preferably between 3° C./min and 7° C./min. Rates of temperature decrease may be similarly controlled and suitably generally of between about 0.5° C./min and 10° C./min, and preferably between 2° C./min and 7° C./min. The time period for holding the temperature at the maximum target temperature may be, for example, between 30 and 300 minutes, or between 60 and 240 minutes, and preferably between 60 and 120 minutes. Accordingly, the total time period of pyrolysis, from room temperature to a return to room temperature, may occupy several hours. By contrast, in previous processes for the pyrolytic conversion of a green body to a PDC material, there tends to be a high rate of increase of the temperature, a higher pyrolysis maximum temperature. There may also be a shorter time period of pyrolysis. The preferred conditions for forming the porous ceramic articles are much more gentle and achieve controlled formation of the porous structure.

### EXAMPLES

The TGA₈₅₀ method for determining ceramic yield of organosilicon monomers is as follows.

A known amount of a functionalised organosilicon monomer (preferably between 10 mg and 20 mg) was transferred to an alumina crucible approved for the thermogravimetric analyser in use. The crucible was placed in the analyser and its weight change with respect to time and temperature was studied as per the manufacturers' instructions. The sample crucible was subjected to a thermal cycle under nitrogen from room temperature to 850° C. and then back to room temperature. The sample was equilibrated at 30° C. for 30 minutes, and the resulting weight was tarred before increasing the temperature from 30° C. to 850° C. at a ramp rate of 1° C./minute. The sample was further equilibrated at 850° C. for 60 minutes before cooling down from 850° C. to room temperature at a rate of 5° C./min. The percentage change in weight of the sample during this thermal cycle is used to calculate the ceramic yield, where the percentage ceramic yield is calculated as (1-sample weight lost/initial sample weight)*100.

A summary of the materials and pyrolytic conditions used for producing porous PDC materials is given in Table 1.

TABLE 1
Materials and conditions used for producing polymer-derived ceramic materials of Examples 1 to 11.

| | | | | | |
|---|---|---|---|---|---|
| | | Porous ceramic | | | |
| Ex. | Monomer(s) | nanoparticle | Porogen | Pyrolysis | Porosity |

Silicon oxycarbide ceramic

| | | | | | |
|---|---|---|---|---|---|
| 1 | Methacryloxypropyl terminated polydimethylsiloxane | Silica, 5-20 nm | | ≤600° C., N₂ | Low |
| | | (TEM), 2-5 nm pores | | | |
| 2 | Methacryloxypropyl terminated polydimethylsiloxane, (Mercaptopropyl) | Silica, 5-20 nm | | ≤600° C., N₂ | Very |
| | methylsiloxane homopolymer (1:1.25 Molar Ratio) | (TEM), 2-5 nm pores | | | High |
| 3 | (Mercaptopropyl) methylsiloxane homopolymer, Vinylmethoxysiloxane | Silica, 5-20 nm | | ≤600° C., N₂ | Medium |
| | homopolymer (1:1 Molar Ratio) | (TEM), 2-5 nm pores | | | |
| 7 | Methacryloxypropyl terminated polydimethylsiloxane, (Mercaptopropyl) | | | ≤600° C., N₂ | Medium |
| | methylsiloxane homopolymer (1:1.25 Molar Ratio) | | | | |
| 12 | (Mercaptopropyl) methylsiloxane homopolymer, Vinylmethoxysiloxane | Silica, 5-20 nm | | ≤600° C., N₂ | Very |
| | homopolymer (1:1.25 Molar Ratio) | (TEM), 2-5 nm pores | | | High |
| 13 | Methacryloxypropyl terminated polydimethylsiloxane, (Mercaptopropyl) | Silica, 5-20 nm | | ≤600° C., N₂ | Very |
| | methylsiloxane homopolymer (1:1 Molar Ratio) | (TEM), 2-5 nm pores | | | High |
| 14 | Methacryloxypropyl terminated polydimethylsiloxane, (Mercaptopropyl) | Silica, 5-20 nm | PEG400 | ≤600° C., N₂ | Very |
| | methylsiloxane homopolymer (1:1 Molar Ratio) | (TEM), 2-5 nm pores | | | High |
| 16 | (Mercaptopropyl) methylsiloxane homopolymer, methacryloxypropyl | Silica, 5-20 nm | | ≤600° C., | Very |
| | terminated polydimethylsiloxane (1:1 Molar Ratio) | (TEM), 2-5 nm pores | | Vacuum | High |

Silica ceramic

| | | | | | |
|---|---|---|---|---|---|
| 4 | Methacryloxypropyl terminated polydimethylsiloxane | Silica, 5-20 nm | | ≤700° C., Air | Low |
| | | (TEM), 2-5 nm pores | | | |
| 5 | Methacryloxypropyl terminated polydimethylsiloxane, (Mercaptopropyl) | Silica, 5-20 nm | | ≤700° C., Air | Very |
| | methylsiloxane homopolymer (100:100 parts) | (TEM), 2-5 nm pores | | | High |
| 6 | (Mercaptopropyl) methylsiloxane homopolymer, Vinylmethoxysiloxane | Silica, 5-20 nm | | ≤700° C., Air | Medium |
| | homopolymer (100:100 parts) | (TEM), 2-5 nm pores | | | |
| 8 | (Mercaptopropyl) methylsiloxane homopolymer, methacryloxypropyl | | | ≤700° C., Air | Medium |
| | terminated polydimethylsiloxane, methacryloxypropyl substituted | | | | |
| | poly(isobutyl-t8-silsesquioxane) (100:100:30 parts) | | | | |
| 9 | Methacryloxypropyl terminated polydimethylsiloxane, (Mercaptopropyl) | Silica, 5-20 nm | PEG400 | ≤700° C., Air | Very |
| | methylsiloxane homopolymer (100:100 parts) | (TEM), 2-5 nm pores | | | High |
| 10 | Methacryloxypropyl terminated polydimethylsiloxane, (Mercaptopropyl) | Silica, 5-20 nm | Toluene | ≤700° C., Air | Very |
| | methylsiloxane homopolymer (100:100 parts) | (TEM), 2-5 nm pores | | | High |
| 11 | (Mercaptopropyl) methylsiloxane homopolymer, (Mercaptopropyl) | | | ≤700° C., Air | Medium |
| | methylsiloxane homopolymer, methacryloxypropyl substituted poly(isobutyl- | | | | |
| | t8-silsesquioxane) (100:100:30 parts) | | | | |

### Example 1—Porous Silicon Oxycarbide

### A First Functionalised Organosilicon Monomer+Porous Ceramic Nanoparticles

A resin was prepared by mixing 100 parts of methacryloxypropyl terminated polydimethylsiloxane with 0.9 parts of phenylbis(2,4,6-trimethylbenzoyl) phosphine oxide, 0.23 parts of 2,5-Bis (5-tert-butyl-benzoxazol-2-yl)thiophene, and 0.8 parts of w/w tert-Butylhydroquinone (TBHQ). Porous silicon dioxide nanoparticles (spherical, 5-20 nm particle size (TEM), mesoporous 3-5 nm, Sigma-Aldrich) (20% w/w) were also added to the resin formulation.

The resin components were mixed thoroughly on a vortex mixer and sonicator bath, and then the prepared resin was purged with nitrogen and vacuumed for an hour.

The resin was 3D printed using a digital light projection (DLP) printer, Miicraft Ultra, as per the manufacturer's standard operating procedure to produce a 3D printed green body.

The resin was also photopolymerised under 365 nm wavelength by casting it into a disc-shaped mould (10 mm diameter and 2 mm thickness) to produce an injection moulded green body.

The green bodies were pyrolysed under constant (3 L/min) nitrogen flow in a tube furnace. The pyrolysis was performed with a ramp rate of 1° C./min from 25° C. to 100° C., followed by 0.5° C./min from 100° C. to 600° C. The furnace was held at 600° C. for 180 minutes. The furnace was then cooled from 600° C. to 450° C. and then to 300° C. at a ramp rate of 2° C./min. The furnace was held at 450° C. and 300° C. for 60 minutes each. It was finally cooled to 25° C. at a ramp rate of 2° C./min to produce 3D printed and injection moulded ceramic articles.

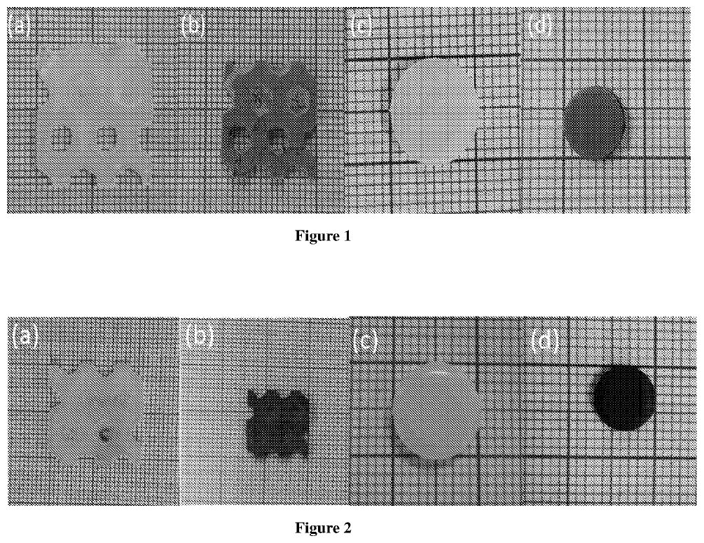

FIG. 1 depicts the 3D printed and injection moulded green bodies, and the pyrolysed 3D printed and injection moulded articles. Pyrolysis of both 3D printed and moulded green bodies into porous silicon oxycarbide retained all the features of the printed and moulded structures and resulted in ca. 30% linear shrinkage.

### Example 2—Porous Silicon Oxycarbide

### A First and Second Functionalised Organosilicon Monomer+Porous Ceramic Nanoparticles

A resin was prepared by mixing 100 parts of (Mercaptopropyl)methylsiloxane homopolymer (ca. 55% ceramic yield) and 100 parts of methacryloxypropyl terminated polydimethylsiloxane (ca. 18% ceramic yield) with 0.9 parts of phenylbis(2,4,6-trimethylbenzoyl) phosphine oxide, 0.23 parts of 2,5-Bis (5-tert-butyl-benzoxazol-2-yl)thiophene, and 0.8 parts of w/w tert-Butylhydroquinone (TBHQ). Porous silicon dioxide nanoparticles (spherical, 5-20 nm particle size (TEM), mesoporous 3-5 nm, Sigma-Aldrich) (20% w/w) were added to this resin.

The resin components were mixed thoroughly on a vortex mixer and sonicator bath, and then the prepared resin was purged with nitrogen and vacuumed for an hour.

The resin was 3D printed using a digital light projection (DLP) printer, Miicraft Ultra, as per the manufacturer's standard operating procedure to produce a 3D printed green body.

The resin was also photopolymerised under 365 nm wavelength by casting it into a disc-shaped mould (10 mm diameter and 2 mm thickness) to produce an injection moulded green body.

The green bodies were pyrolysed under constant (3 L/min) nitrogen flow in a tube furnace. The pyrolysis was performed with a ramp rate of 1° C./min from 25° C. to 100° C., followed by 0.5° C./min from 100° C. to 600° C. The furnace was held at 600° C. for 180 minutes. The furnace was then cooled from 600° C. to 450° C. and then to 300° C. at a ramp rate of 2° C./min. The furnace was held at 450° C. and 300° C. for 60 minutes each. It was finally cooled to 25° C. at a ramp rate of 2° C./min to produce 3D printed and injection moulded ceramic articles.

FIG. 2 depicts the 3D printed and injection moulded green bodies, and the pyrolysed 3D printed and injection moulded articles. Pyrolysis of both 3D printed and injection moulded green bodies into porous silicon oxycarbide retained all the features of the printed and moulded structures and resulted in ca. 30% linear shrinkage.

FIG. 3 is a pore size distribution plot of the pyrolysed 3D printed article as determined using by a BET surface analyser. BET surface area analysis shows the presence of both micro-(<20 Å) and meso-(20-500 Å) pores with a total specific surface area of 474 m²/g.

### Example 3—Porous Silicon Oxycarbide

### A First and Second Functionalised Organosilicon Monomer+Porous Ceramic Nanoparticles

A resin was prepared by mixing 100 parts of (Mercaptopropyl)methylsiloxane homopolymer (ca. 55% ceramic yield) and 100 parts of vinylmethoxysiloxane homopolymer (ca. 50% ceramic yield) with 0.9 parts of phenylbis(2,4,6-trimethylbenzoyl) phosphine oxide, 0.23 parts of 2,5-Bis (5-tert-butyl-benzoxazol-2-yl)thiophene, and 0.8 parts of w/w tert-Butylhydroquinone (TBHQ). Porous silicon dioxide nanoparticles (spherical, 5-20 nm particle size (TEM), mesoporous 3-5 nm, Sigma-Aldrich) (20% w/w) were also added to the resin formulation.

The resin components were mixed thoroughly on a vortex mixer and sonicator bath, and then the prepared resin was purged with nitrogen and vacuumed for an hour.

The resin was 3D printed using a digital light projection (DLP) printer, Miicraft Ultra, as per the manufacturer's standard operating procedure, to produce a 3D printed green body.

The resin was also photopolymerised under 365 nm wavelength by casting it into a disc shaped mould (10 mm diameter and 2 mm thickness) to produce an injection moulded green body.

The green bodies were pyrolysed under constant (3 L/min) nitrogen flow in a tube furnace. The pyrolysis was performed with a ramp rate of 1° C./min from 25° C. to 100° C., followed by 0.5° C./min from 100° C. to 600° C. The furnace was held at 600° C. for 180 minutes. The furnace was then cooled from 600° C. to 450° C. and then to 300° C. at a ramp rate of 2° C./min. The furnace was held at 450° C. and 300° C. for 60 minutes each. It was finally cooled to 25° C. at a ramp rate of 2° C./min to produce 3D printed and injection moulded ceramic articles.

FIG. 4 depicts the 3D printed green body and the pyrolysed 3D printed article. Pyrolysis of the 3D printed green body into porous silicon oxycarbide retained all of the features of the printed structure and resulted in ca. 20% linear shrinkage.

### Example 4—Porous Silica

### A First Functionalised Organosilicon Monomer+Porous Ceramic Nanoparticles

A resin was prepared by mixing 100 parts of methacryloxypropyl terminated polydimethylsiloxane with 0.9 parts of phenylbis(2,4,6-trimethylbenzoyl) phosphine oxide, 0.23 parts of 2,5-Bis (5-tert-butyl-benzoxazol-2-yl)thiophene, and 0.8 parts of w/w tert-Butylhydroquinone (TBHQ). Porous silicon dioxide nanoparticles (spherical, 5-20 nm particle size (TEM), mesoporous 3-5 nm, Sigma-Aldrich) (20% w/w) were also added to the resin formulation.

The resin components were mixed thoroughly on a vortex mixer and sonicator bath, and then the prepared resin was purged with nitrogen and vacuumed for an hour.

The resin was 3D printed using a digital light projection (DLP) printer, Miicraft Ultra, as per the manufacturer's standard operating procedure to produce a 3D printed green body.

The resin was also photopolymerised under 365 nm wavelength by casting it into a disc-shaped mould (10 mm diameter and 2 mm thickness) to produce an injection moulded green body.

The green bodies were pyrolysed under constant (1 L/min) flow of air in a tube furnace. The pyrolysis was performed with a ramp rate of 1° C./min from 25° C. to 100° C., followed by 0.5° C./min from 100° C. to 600° C. The furnace was held at 600° C. for 180 minutes followed by a ramp rate of 7° C./min from 600° C. to a temperature of 700° C. and then held at 700° C. for 60 minutes. The furnace was then cooled from 700° C. to 450° C. at a ramp rate of 7° C./min and then to 300° C. at a ramp rate of 2° C./min. The furnace was held at 450° C. and 300° C. for 60 minutes each. It was finally cooled to 25° C. at a ramp rate of 2° C./min to produce 3D printed and injection moulded ceramic articles.

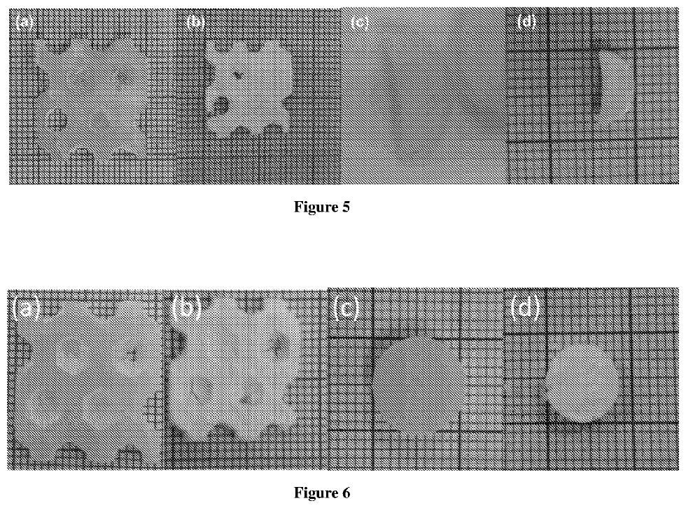

FIG. 5 depicts the 3D printed and injection moulded green bodies, and the pyrolysed 3D printed and injection moulded articles. Pyrolysis of both 3D printed and injection moulded green bodies into porous silica retained all the printed and moulded structural features and resulted in ca. 20% linear shrinkage.

### Example 5—Porous Silica

### A First and Second Functionalised Organosilicon Monomer+Porous Ceramic Nanoparticles

A resin was prepared by mixing 100 parts of (Mercaptopropyl)methylsiloxane homopolymer (ca. 55% ceramic yield) and 100 parts of methacryloxypropyl terminated polydimethylsiloxane (ca. 18% ceramic yield) with 0.9 parts of phenylbis(2,4,6-trimethylbenzoyl) phosphine oxide, 0.23 parts of 2,5-Bis (5-tert-butyl-benzoxazol-2-yl)thiophene, and 0.8 parts of w/w tert-Butylhydroquinone (TBHQ). Porous silicon dioxide nanoparticles (spherical, 5-20 nm particle size (TEM), mesoporous 3-5 nm, Sigma-Aldrich) (20% w/w) were added to this resin.

The resin components were mixed thoroughly on a vortex mixer and sonicator bath, and then the prepared resin was purged with nitrogen and vacuumed for an hour.

The resin was 3D printed using a digital light projection (DLP) printer, Miicraft Ultra, as per the manufacturer's standard operating procedure to produce a 3D printed green body.

The resin was also photopolymerised under 365 nm wavelength by casting it into a disc-shaped mould (10 mm diameter and 2 mm thickness) to produce an injection moulded green body.

The green bodies were pyrolysed under constant (1 L/min) air flow in a tube furnace. The pyrolysis was performed with a ramp rate of 1° C./min from 25° C. to 100° C., followed by 0.5° C./min from 100° C. to 600° C. The furnace was held at 600° C. for 180 minutes followed by a ramp rate of 7° C./min from 600° C. to a temperature of 700° C. and then held at 700° C. for 60 minutes. The furnace was then cooled from 700° C. to 450° C. at a ramp rate of 7° C./min and then to 300° C. at a ramp rate of 2° C./min. The furnace was held at 450° C. and 300° C. for 60 minutes each. It was finally cooled to 25° C. at a ramp rate of 2° C./min to produce 3D printed and injection moulded ceramic articles.

FIG. 6 depicts the 3D printed and injection moulded green bodies, and the pyrolysed 3D printed and injection moulded articles. Pyrolysis of 3D printed and moulded green bodies into porous silica retained all the features of the printed structure and resulted in only 15% linear shrinkage.

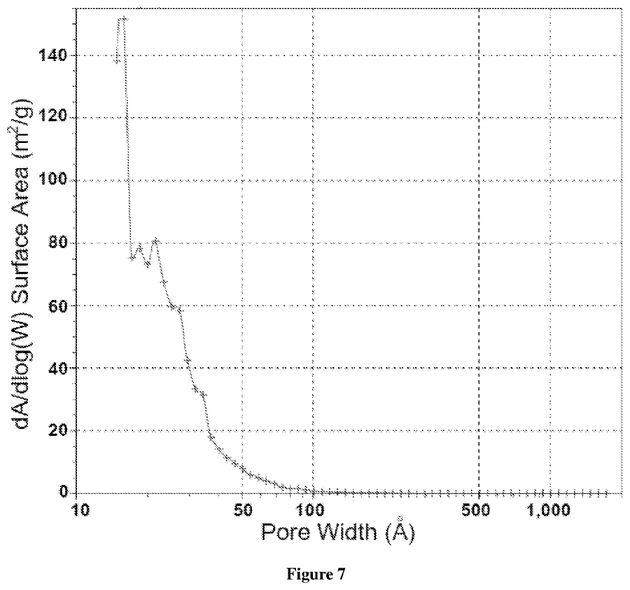

FIG. 7 is a pore size distribution plot of the pyrolysed 3D printed article as determined using by a BET surface analyser. BET surface area analysis shows the presence of both micro-(<20 Å) and meso-(20-500 Å) pores with a total specific surface area of 165 m²/g.

FIG. 8 is a pore size distribution plot of the pyrolysed 3D printed article as determined using mercury porosimetry. The presence of macro-pores (>0.05 μm) was confirmed by mercury porosimetry measurements.

### Example 6—Porous Silica

### A First and Second Functionalised Organosilicon Monomer+Porous Ceramic Nanoparticles

A resin was prepared by mixing 100 parts of (Mercaptopropyl)methylsiloxane homopolymer (ca. 55% ceramic yield) and 100 parts of vinylmethoxysiloxane homopolymer (ca. 50% ceramic yield) with 0.9 parts of phenylbis(2,4,6-trimethylbenzoyl) phosphine oxide, 0.23 parts of 2,5-Bis (5-tert-butyl-benzoxazol-2-yl)thiophene, and 0.8 parts of w/w tert-Butylhydroquinone (TBHQ). Porous silicon dioxide nanoparticles (spherical, 5-20 nm particle size (TEM), mesoporous 3-5 nm, Sigma-Aldrich) (20% w/w) were also added to the resin formulation.

The resin components were mixed thoroughly on a vortex mixer and sonicator bath, and then the prepared resin was purged with nitrogen and vacuumed for an hour.

The resin was 3D printed using a digital light projection (DLP) printer, Miicraft Ultra, as per the manufacturer's standard operating procedure to produce a 3D printed green body.

The resin was also photopolymerised under 365 nm wavelength by casting it into a disc-shaped mould (10 mm diameter and 2 mm thickness) to produce an injection moulded green body.

The green bodies were pyrolysed under constant (1 L/min) flow of air in a tube furnace. The pyrolysis was performed with a ramp rate of 1° C./min from 25° C. to 100° C., followed by 0.5° C./min from 100° C. to 600° C. The furnace was held at 600° C. for 180 minutes followed by a ramp rate of 7° C./min from 600° C. to a temperature of 700° C. and then held at 700° C. for 60 minutes. The furnace was then cooled from 700° C. to 450° C. at a ramp rate of 7° C./min and then to 300° C. at a ramp rate of 2° C./min. The furnace was held at 450° C. and 300° C. for 60 minutes each. It was finally cooled to 25° C. at a ramp rate of 2° C./min to produce 3D printed and injection moulded ceramic articles.

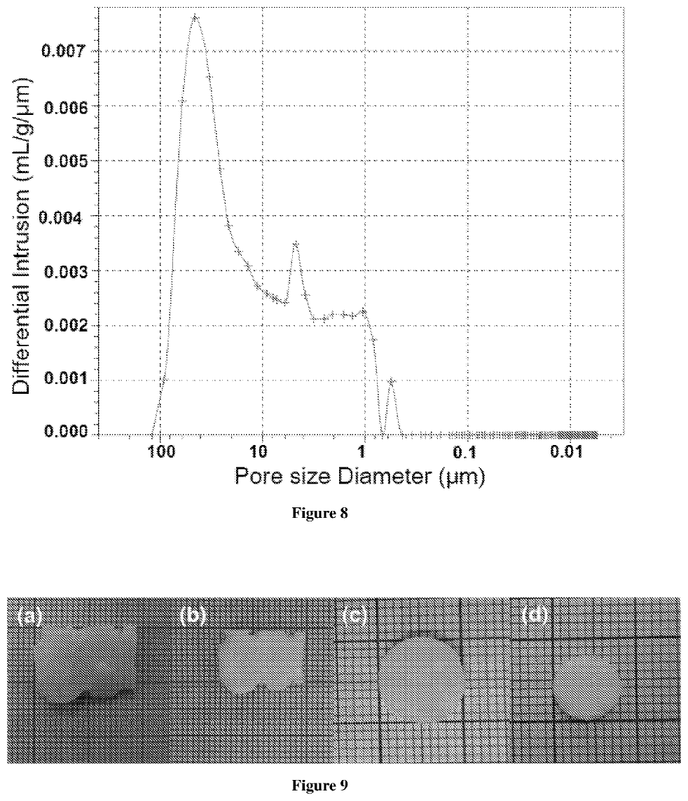

FIG. 9 depicts the 3D printed and injection moulded green bodies, and the pyrolysed 3D printed and injection moulded articles. Pyrolysis of both 3D printed and moulded green bodies into porous silica retained all the features of the printed and moulded structures and resulted in ca. 20% linear shrinkage.

BET surface area analysis measured a total specific surface area of 57.6 m²/g

### Example 7—Porous Silicon Oxycarbide

### A First and Second Functionalised Organosilicon Monomer

A resin was prepared by mixing 100 parts of (Mercaptopropyl)methylsiloxane homopolymer (ca. 55% ceramic yield) and 100 parts of methacryloxypropyl terminated polydimethylsiloxane (ca. 18% ceramic yield) with 0.9 parts of phenylbis(2,4,6-trimethylbenzoyl) phosphine oxide, 0.23 parts of 2,5-Bis (5-tert-butyl-benzoxazol-2-yl)thiophene, and 0.8 parts of w/w tert-Butylhydroquinone (TBHQ).

The resin components were mixed thoroughly on a vortex mixer and sonicator bath, and then the prepared resin was purged with nitrogen and vacuumed for an hour.

The resin was photopolymerised under 365 nm wavelength by casting it into a disc-shaped mould (10 mm diameter and 2 mm thickness) to produce an injection moulded green body.

The green body was pyrolysed under a constant (3 L/min) nitrogen flow in a tube furnace. The pyrolysis was performed with a ramp rate of 1° C./min from 25° C. to 100° C., followed by 0.5° C./min from 100° C. to 600° C. The furnace was held at 600° C. for 180 minutes. The furnace was then cooled from 600° C. to 450° C. and then to 300° C. at a ramp rate of 2° C./min. The furnace was held at 450° C. and 300° C. for 60 minutes each. It was finally cooled to 25° C. at a ramp rate of 2° C./min to produce an injection moulded ceramic article.

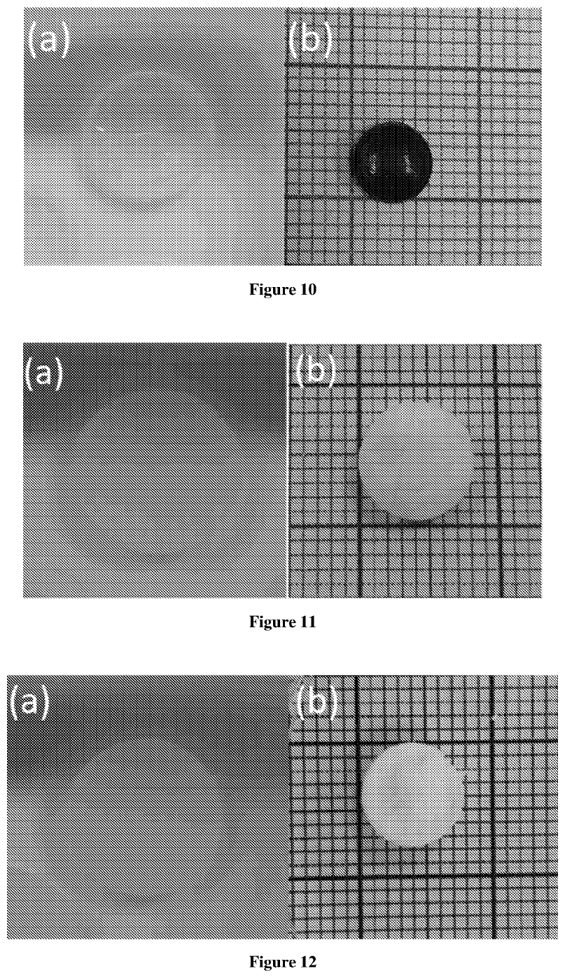

FIG. 10 depicts the injection moulded green body and the pyrolysed injection moulded articles. Pyrolysis of the moulded body retained all its features and resulted in a ca. 40% linear shrinkage.

### Example 8—Porous Silica

### A First, Second and Third Functionalised Organosilicon Monomer Including Polyoctahedral Silsesquioxane

A resin was prepared by mixing 100 parts of (Mercaptopropyl)methylsiloxane homopolymer 100 parts of methacryloxypropyl terminated polydimethylsiloxane, and 30 parts of methacryloxypropyl substituted poly(isobutyl-t8-silsesquioxane) with 0.9 parts of phenylbis(2,4,6-trimethylbenzoyl) phosphine oxide, 0.23 parts of 2,5-Bis (5-tert-butyl-benzoxazol-2-yl)thiophene, and 0.8 parts of w/w tert-Butylhydroquinone (TBHQ).

The resin components were mixed thoroughly on a vortex mixer and sonicator bath, and then the prepared resin was purged with nitrogen and vacuumed for an hour.

The resin was photopolymerised under 365 nm wavelength by casting it into a disc-shaped mould (10 mm diameter and 2 mm thickness) to produce an injection moulded green body.

The green body was pyrolysed under a constant (1 L/min) air flow in a tube furnace. The pyrolysis was performed with a ramp rate of 1° C./min from 25° C. to 100° C., followed by 0.5° C./min from 100° C. to 600° C. The furnace was held at 600° C. for 180 minutes followed by a ramp rate of 7° C./min from 600° C. to a temperature of 700° C. and then held at 700° C. for 60 minutes. The furnace was then cooled from 700° C. to 450° C. at a ramp rate of 7° C./min and then to 300° C. at a ramp rate of 2° C./min. The furnace was held at 450° C. and 300° C. for 60 minutes each. It was finally cooled to 25° C. at a ramp rate of 2° C./min to produce an injection moulded ceramic article.

FIG. 11 depicts the injection moulded green body and the pyrolysed injection moulded articles. Pyrolysis of injection moulded green body into porous silicon oxycarbide retained all the features of the moulded structure and resulted in ca. 15% linear shrinkage.

BET surface area analysis measured a total specific surface area of 46.7 m²/g.

### Example 9—Porous Silica

### A First and Second Functionalised Organosilicon Monomer+Porous Ceramic Nanoparticles+Porogen

A resin was prepared by mixing 100 parts of (Mercaptopropyl)methylsiloxane homopolymer and 100 parts of methacryloxypropyl terminated polydimethylsiloxane with 10 parts of polyethylene glycol 400 as a porogen, 0.9 parts of phenylbis(2,4,6-trimethylbenzoyl) phosphine oxide, 0.23 parts of 2,5-Bis (5-tert-butyl-benzoxazol-2-yl)thiophene, and 0.8 parts of w/w tert-Butylhydroquinone (TBHQ). Porous silicon dioxide nanoparticles (spherical, 5-20 nm particle size (TEM), mesoporous 3-5 nm, Sigma-Aldrich) (20% w/w) were also added to the resin formulation.

The resin components were mixed thoroughly on a vortex mixer and sonicator bath, and then the prepared resin was purged with nitrogen and vacuumed for an hour.

The resin was photopolymerised under 365 nm wavelength by casting it into a disc-shaped mould (10 mm diameter and 2 mm thickness) to produce an injection moulded green body.

The green body was pyrolysed under a constant (1 L/min) air flow in a tube furnace. The pyrolysis was performed with a ramp rate of 1° C./min from 25° C. to 100° C., followed by 0.5° C./min from 100° C. to 600° C. The furnace was held at 600° C. for 180 minutes followed by a ramp rate of 7° C./min from 600° C. to a temperature of 700° C. and then held at 700° C. for 60 minutes. The furnace was then cooled from 700° C. to 450° C. at a ramp rate of 7° C./min and then to 300° C. at a ramp rate of 2° C./min. The furnace was held at 450° C. and 300° C. for 60 minutes each. It was finally cooled to 25° C. at a ramp rate of 2° C./min to produce an injection moulded ceramic article.

FIG. 12 depicts the injection moulded green body and the pyrolysed injection moulded articles. Pyrolysis retained all the features of the moulded body and resulted in ca. 20% linear shrinkage.

BET surface area analysis measured a total specific surface area of 137 m²/g.

### Example 10—Porous Silica

### A First and Second Functionalised Organosilicon Monomer+Porous Ceramic Nanoparticles+Porogen

A resin was prepared by mixing 100 parts of (Mercaptopropyl)methylsiloxane homopolymer and 100 parts of methacryloxypropyl terminated polydimethylsiloxane with 10 parts of toluene as a porogen, 0.9 parts of phenylbis(2,4,6-trimethylbenzoyl) phosphine oxide, 0.23 parts of 2,5-Bis (5-tert-butyl-benzoxazol-2-yl)thiophene, and 0.8 parts of w/w tert-Butylhydroquinone (TBHQ). Porous silicon dioxide nanoparticles (spherical, 5-20 nm particle size (TEM), mesoporous 3-5 nm, Sigma-Aldrich) (20% w/w) were also added to the resin formulation.

The resin components were mixed thoroughly on a vortex mixer and sonicator bath, and then the prepared resin was purged with nitrogen and vacuumed for an hour.

The resin was photopolymerised under 365 nm wavelength by casting it into a disc-shaped mould (10 mm diameter and 2 mm thickness) to produce an injection moulded green body.

The green body was pyrolysed under a constant (1 L/min) flow of air in a tube furnace. The pyrolysis was performed with a ramp rate of 1° C./min from 25° C. to 100° C., followed by 0.5° C./min from 100° C. to 600° C. The furnace was held at 600° C. for 180 minutes followed by a ramp rate of 7° C./min from 600° C. to a temperature of 700° C. and then held at 700° C. for 60 minutes. The furnace was then cooled from 700° C. to 450° C. at a ramp rate of 7° C./min and then to 300° C. at a ramp rate of 2° C./min. The furnace was held at 450° C. and 300° C. for 60 minutes each. It was finally cooled to 25° C. at a ramp rate of 2° C./min to produce an injection moulded ceramic article.

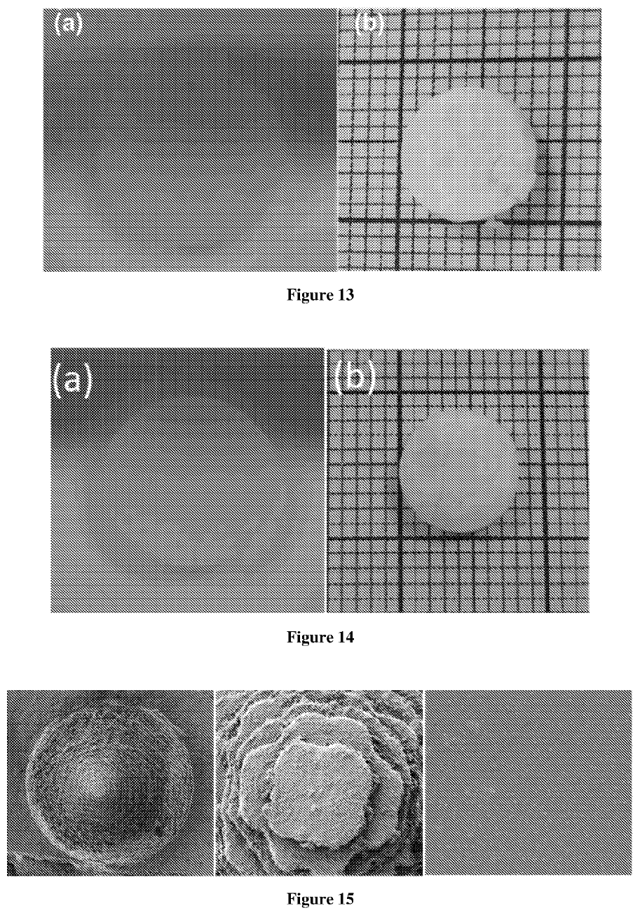

FIG. 13 depicts the injection moulded green body and the pyrolysed injection moulded articles. Pyrolysis retained all the features of the moulded body and resulted in ca. 20% linear shrinkage.

BET surface area analysis measured a total specific surface area of 164 m²/g.

### Example 11—Porous Silica

### A First and Second Functionalised Organosilicon PDC Monomer Including Polyoctahedral Silsesquioxane

A resin was prepared by mixing 100 parts of (Mercaptopropyl)methylsiloxane homopolymer 100 parts of methacryloxypropyl terminated polydimethylsiloxane, and 30 parts of methacryloxypropyl substituted poly(isobutyl-t8-silsesquioxane) with 0.9 parts of phenylbis(2,4,6-trimethylbenzoyl) phosphine oxide, 0.23 parts of 2,5-Bis (5-tert-butyl-benzoxazol-2-yl)thiophene, and 0.8 parts of w/w tert-Butylhydroquinone (TBHQ).

The resin components were mixed thoroughly on a vortex mixer and sonicator bath, and then the prepared resin was purged with nitrogen and vacuumed for an hour.

The resin was photopolymerised under 365 nm wavelength by casting it into a disc-shaped mould (10 mm diameter and 2 mm thickness) to produce an injection moulded green body.

The green body was pyrolysed under a constant (1 L/min) flow of air in a tube furnace. The pyrolysis was performed with a ramp rate of 1° C./min from 25° C. to 100° C., followed by 0.5° C./min from 100° C. to 600° C. The furnace was held at 600° C. for 180 minutes followed by a ramp rate of 7° C./min from 600° C. to a temperature of 700° C. and then held at 700° C. for 60 minutes. The furnace was then cooled from 700° C. to 450° C. at a ramp rate of 7° C./min and then to 300° C. at a ramp rate of 2° C./min. The furnace was held at 450° C. and 300° C. for 60 minutes each. It was finally cooled to 25° C. at a ramp rate of 2° C./min to produce an injection moulded ceramic article.

FIG. 14 depicts the injection moulded green body and the pyrolysed injection moulded article. Pyrolysis of injection moulded green body into porous silica retained all the features of the moulded structure and resulted in ca. 15% linear shrinkage.

BET surface area analysis measured a total specific surface area of 47 m²/g.

### Example 12—Porous Silicon Oxycarbide

### A First and Second Functionalised Organosilicon Monomer+Porous Ceramic Nanoparticles

A resin was prepared by mixing 100 parts of (Mercaptopropyl)methylsiloxane homopolymer (ca. 55% ceramic yield) and 70 parts of vinylmethoxysiloxane homopolymer (ca. 50% ceramic yield) with 0.9 parts of phenylbis(2,4,6-trimethylbenzoyl) phosphine oxide, 0.23 parts of 2,5-Bis (5-tert-butyl-benzoxazol-2-yl)thiophene, and 0.8 parts of w/w tert-Butylhydroquinone (TBHQ). Porous silicon dioxide nanoparticles (spherical, 5-20 nm particle size (TEM), mesoporous 3-5 nm, Sigma-Aldrich) (16% w/w; 34 parts) were added to this resin.

The resin components were mixed thoroughly on a vortex mixer and sonicator bath, and then the prepared resin was purged with nitrogen and vacuumed for an hour.

The resin was 3D printed into a designed microneedle patch structure using a digital light projection (DLP) printer, Miicraft Ultra, as per the manufacturer's standard operating procedure to produce a 3D printed green body.

The green body was pyrolysed under constant (3 L/min) nitrogen flow in a tube furnace. The pyrolysis was performed with a ramp rate of 1° C./min from 25° C. to 100° C., followed by 0.2° C./min from 100° C. to 600° C. The furnace was held at 600° C. for 180 minutes. The furnace was then cooled from 600° C. to 450° C. and then to 300° C. at a ramp rate of 2° C./min. The furnace was held at 450° C. and 300° C. for 60 minutes each. It was finally cooled to 25° C. at a ramp rate of 7° C./min to produce a 3D printed ceramic microneedle patch article.

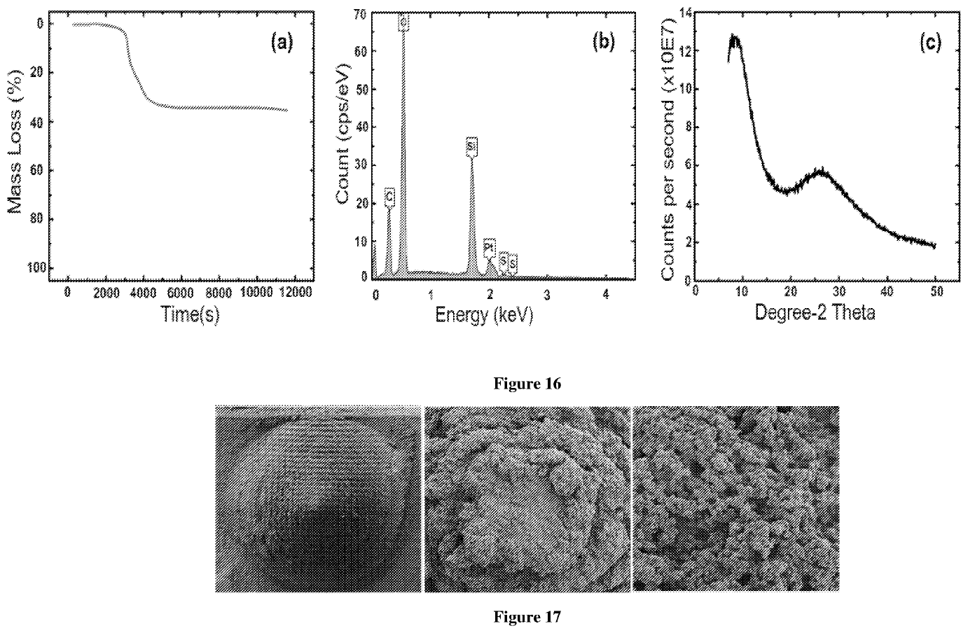

FIG. 15 depicts close-up images of a pyrolysed 3D printed microneedle. Pyrolysis of 3D printed moulded green bodies into porous silicon oxycarbide retained all the features of the printed and moulded structures and resulted in ca. 15% linear shrinkage. BET surface area analysis showed an average pore size of 1.6 nm (as shown in FIG. 24), a total specific surface area of 357 m²/g and a pore volume of 0.12 cm³/g. The pyrolysed structures had an empirical formula of SiO_{2.05}C_{1.06}S_{0.04} and were found to be amorphous. FIG. 16 shows the results of the (a) TGA of the resin, (b) EDEX (elemental analysis) of the pyrolysed body, and (c) XRD of the pyrolysed body.

### Example 13—Porous Silicon Oxycarbide

### A First and Second Functionalised Organosilicon Monomer+Porous Ceramic Nanoparticles

A resin was prepared by mixing 100 parts of (Mercaptopropyl)methylsiloxane homopolymer (ca. 55% ceramic yield) and 100 parts of methacryloxypropyl terminated polydimethylsiloxane (ca. 18% ceramic yield) with 0.9 parts of phenylbis(2,4,6-trimethylbenzoyl) phosphine oxide, 0.23 parts of 2,5-Bis (5-tert-butyl-benzoxazol-2-yl)thiophene, and 0.8 parts of w/w tert-Butylhydroquinone (TBHQ). Porous silicon dioxide nanoparticles (spherical, 5-20 nm particle size (TEM), mesoporous 3-5 nm, Sigma-Aldrich) (20% w/w; 40 parts) were added to this resin.

The resin components were mixed thoroughly on a vortex mixer and sonicator bath, and then the prepared resin was purged with nitrogen and vacuumed for an hour.

The resin was 3D printed into a designed microneedle patch structure using a digital light projection (DLP) printer, Miicraft Ultra, as per the manufacturer's standard operating procedure to produce a 3D printed green body.

The green body was pyrolysed under constant (3 L/min) nitrogen flow in a tube furnace. The pyrolysis was performed with a ramp rate of 1° C./min from 25° C. to 100° C., followed by 0.2° C./min from 100° C. to 600° C. The furnace was held at 600° C. for 180 minutes. The furnace was then cooled from 600° C. to 450° C. and then to 300° C. at a ramp rate of 2° C./min. The furnace was held at 450° C. and 300° C. for 60 minutes each. It was finally cooled to 25° C. at a ramp rate of 7° C./min to produce a 3D printed ceramic microneedle patch article.

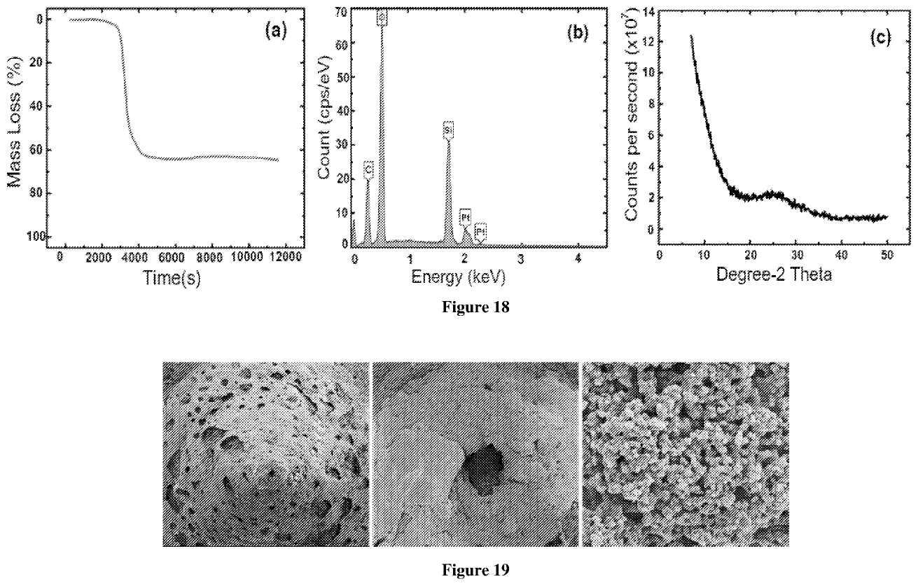

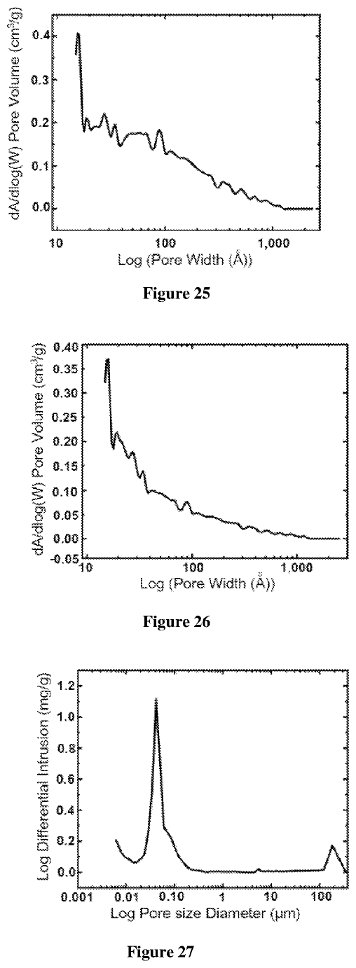

FIG. 17 depicts close-up images of a pyrolysed 3D printed microneedle. Pyrolysis of 3D printed moulded green bodies into porous silicon oxycarbide retained all the features of the printed and moulded structures and resulted in ca. 30% linear shrinkage. BET surface area analysis showed pore sizes ranging from of 1.6 nm to 7 nm (as shown in FIG. 25), a total specific surface area of 524.7 m²/g and a pore volume of 0.38 cm³/g. The resin resulted in a ceramic yield of 35%. The pyrolysed structures had a total carbon content of 14 wt % with an empirical formula of SiO_{2.01}C_{1.19}S_{0.004} and were found to be amorphous. FIG. 18 shows the results of the (a) TGA of the resin, (b) EDEX (elemental analysis) of the pyrolysed body, and (c) XRD of the pyrolysed body.

### Example 14—Porous Silicon Oxycarbide

### A First and Second Functionalised Organosilicon Monomer+Porous Ceramic Nanoparticles+Porogen

A resin was prepared by mixing 100 parts of (Mercaptopropyl)methylsiloxane homopolymer (ca. 55% ceramic yield) and 100 parts of methacryloxypropyl terminated polydimethylsiloxane (ca. 18% ceramic yield) with 0.9 parts of phenylbis(2,4,6-trimethylbenzoyl) phosphine oxide, 0.23 parts of 2,5-Bis (5-tert-butyl-benzoxazol-2-yl)thiophene, and 0.8 parts of w/w tert-Butylhydroquinone (TBHQ). Porous silicon dioxide nanoparticles (spherical, 5-20 nm particle size (TEM), mesoporous 3-5 nm, Sigma-Aldrich) (20% w/w; 40 parts) and PEG400 porogen (20 parts) were added to this resin.

The resin components were mixed thoroughly on a vortex mixer and sonicator bath, and then the prepared resin was purged with nitrogen and vacuumed for an hour.

The resin was 3D printed into a designed microneedle patch structure using a digital light projection (DLP) printer, Miicraft Ultra, as per the manufacturer's standard operating procedure to produce a 3D printed green body.

The green body was pyrolysed under constant (3 L/min) nitrogen flow in a tube furnace. The pyrolysis was performed with a ramp rate of 1° C./min from 25° C. to 100° C., followed by 0.2° C./min from 100° C. to 600° C. The furnace was held at 600° C. for 180 minutes. The furnace was then cooled from 600° C. to 450° C. and then to 300° C. at a ramp rate of 2° C./min. The furnace was held at 450° C. and 300° C. for 60 minutes each. It was finally cooled to 25° C. at a ramp rate of 7° C./min to produce a 3D printed ceramic microneedle patch article. During ramp-up, a complete loss of PEG400 was observed by 500° C.

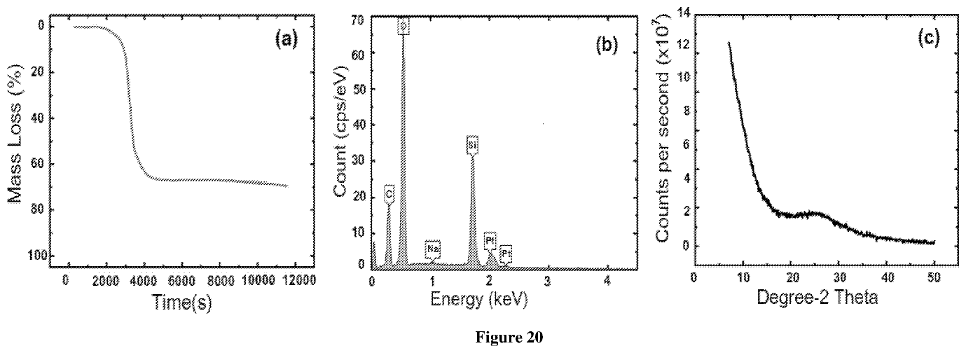

FIG. 19 depicts close-up images of a pyrolysed 3D printed microneedle. Pyrolysis of 3D printed moulded green bodies into porous silicon oxycarbide retained all the features of the printed and moulded structures and resulted in ca. 30% linear shrinkage. BET surface area analysis and Mercury Porosimetry showed the presence of macropores ranging in size from 20 to 200 nm along with micro- and mesoporosity (as shown in FIGS. 26 and 27), a total specific surface area of 527.1 m²/g, a pore volume of 0.3 cm³/g and 47.6% porosity. The resin resulted in a ceramic yield of 30%. The pyrolysed structures had an empirical formula of Si₁O_{1.92}C_{1.02}S_{0.015} and were found to be amorphous. FIG. 20 shows the results of the (a) TGA of the resin, (b) EDEX (elemental analysis) of the pyrolysed body, and (c) XRD of the pyrolysed body.

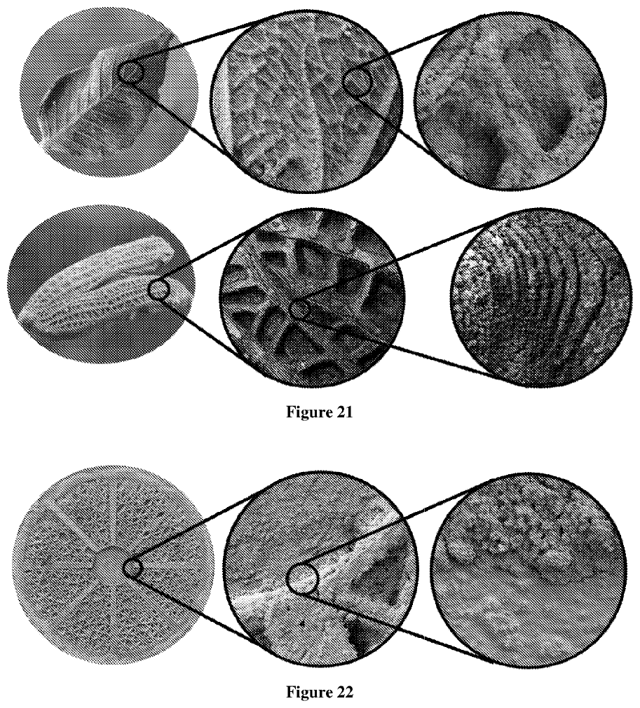

The same resin was also used to replicate naturally occurring porous structures to demonstrate the capability for 3D printing high-resolution complex geometries and architectures. The resin was 3D-printed into a leaf and an insect wing structure using a digital light projection (DLP) printer as above, to produce a 3D printed green body, which was pyrolyzed as above. As shown in FIG. 21, the leaf maintained its external features, such as reticulate venation and ovate shape and internal multi-level porosity. Similarly, the insect wing maintained the shape and structure of its cross veins and scales.

### Example 15—Porous Silicon Oxycarbide

The resins of Examples 13 and 14 were also 3D-printed into a diatom using a digital light projection (DLP) printer as above, with vats containing the different resins interchanged for different printing layers as needed. The valve was 3D printed with the resin of Example 13, while the frustule was 3D printed with the resin of Example 14.

As shown in FIG. 22, the diatom retained structural integrity and high definition. The SEM imaging demonstrated the micro-, meso-, and macro-porous nature of the printed frustule and the micro- and meso-porous nature of the valve.

### Example 16—Porous Silicon Oxycarbide

### A First and Second Functionalised Organosilicon Monomer+Porous Ceramic Particles

A resin was prepared by mixing 100 parts of methacryloxypropyl terminated polydimethylsiloxane (ca. 12% ceramic yield) with 100 parts of (Mercaptopropyl)methylsiloxane homopolymer (ca. 55% ceramic yield) (i.e. 1:1 weight ratio of first and second functionalised organosilicon monomers) with 5 parts of porous silica nanoparticles (10-20 nm particle size), 0.4 parts of phenylbis(2,4,6-trimethylbenzoyl) phosphine oxide (BAPO), 0.23 parts of 2,5-Bis (5-tert-butyl-benzoxazol-2-yl)thiophene (BBOT), and 0.8 parts of w/w tert-Butylhydroquinone (TBHQ).

The resin components were mixed thoroughly on a vortex mixer and sonicator bath, and then the prepared resin was purged with nitrogen and vacuumed for an hour.

A microfluidic chip was 3D printed with this resin using a digital light projection (DLP) printer, Miicraft Ultra, as per the manufacturer's standard operating procedure, to produce a 3D-printed green body.

The printed chip was pyrolyzed under a vacuum in a tube furnace. The pyrolysis was performed with a ramp rate of 1° C./min from 25° C. to 100° C., followed by 0.5° C./min from 100° C. to 600° C. The temperature was held at 600° C. for 180 minutes followed by cooling to 450° C. at a ramp rate of 2° C./min and holding for 60 minutes, then cooling to 300° C. at a ramp rate of 2° C./min and holding for 60 minutes. Cooled then continued to 25° C. at a ramp rate of 2° C./min.

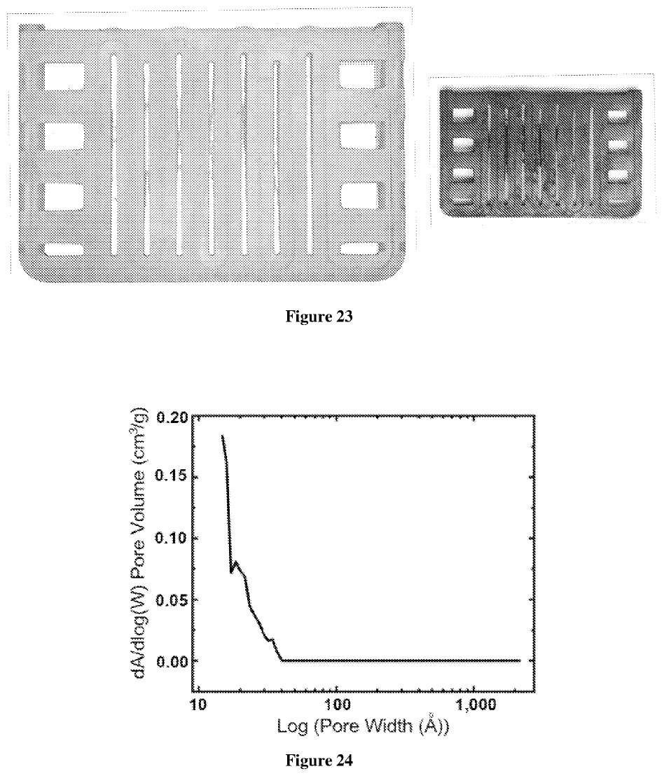

The microfluidic chip is shown in FIG. 23 before (left) and after (right) pyrolysis.

A summary of the materials and conditions used for producing porous polymer-derived ceramic materials of additional prophetic Examples is given in Table 2.

TABLE 2
Materials and conditions used for producing polymer-derived ceramic materials of additional Examples.

| | | | | | |
|---|---|---|---|---|---|
| | | Porous ceramic | | | |
| Ex. | Monomer(s) | particle | Porogen | Pyrolysis | Porosity |

Silica ceramic

| | | | | |
|---|---|---|---|---|
| P1 | Methacryloxypropyl terminated polydimethylsiloxane, (Mercaptopropyl) | Silica | ≤700° C., O₂ | High |
| | methylsiloxane homopolymer (100:100 parts) | nanoparticles | | |
| P2 | (Mercaptopropyl) methylsiloxane homopolymer, Vinylmethoxysiloxane | Silica | ≤700° C., O₂ | Medium |
| | homopolymer (1:1 Molar Ratio) | nanoparticles | | |
| P3 | Methacryloxypropyl terminated polydimethylsiloxane | Silica | ≤700° C., O₂ | Low |

Silicon carbide ceramic nanoparticles

| | | | | |
|---|---|---|---|---|
| P4 | Allylhydrydopolycarbosilane and 1,6-hexandithiol | Silica carbide | | ≤600° C., N₂ |
| P5 | Allylhydrydopolycarbosilane and 1,6-hexandithiol | Silica carbide | PEG400 | ≤600° C., N₂ |

Silicon carbonitride ceramic

| | | | | |
|---|---|---|---|---|
| P6 | Methylvinylhydrogen polycarbosilazane, 1,6-hexandithiol | Silica | | ≤600° C., N₂ |
| | | carbonitride | | |
| P7 | Allylhydrydopolycarbosilane, 1,6-hexandithiol | Silica | PEG400 | ≤600° C., N₂ |
| | | carbonitride | | |

The above examples are only the preferred examples of the present disclosure. It shall be pointed out that various improvements and modifications could be made by those ordinarily skilled in the art without deviating from the principle of the present disclosure, which shall fall within the protection scope of the present disclosure.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

As used herein, except where the context requires otherwise due to express language or necessary implication, the articles “a” and “an” are used herein to refer to one or to more than one (i.e. to at least one) of the grammatical object of the article. By way of example, “an element” means one element or more than one element.

1-39. (canceled)

40. A preceramic resin for forming a porous polymer-derived ceramic material, the resin comprising:
a) a first functionalised organosilicon monomer having a first ceramic yield; and
b) one or more of:
i. a second functionalised organosilicon monomer having a second ceramic yield;
ii. a functionalised organic monomer;
iii. porous ceramic particles; and
iv. a porogen

41. The preceramic resin according to claim 40, comprising one of the following combinations:
a) a first functionalised organosilicon monomer having a first ceramic yield and one or both of a second functionalised organosilicon monomer having a second ceramic yield and a functionalised organic monomer;
b) a first functionalised organosilicon monomer having a first ceramic yield and porous ceramic particles;
c) a first functionalised organosilicon monomer having a first ceramic yield and a porogen;
d) a first functionalised organosilicon monomer having a first ceramic yield, porous ceramic particles and a porogen;
e) a first functionalised organosilicon monomer having a first ceramic yield, one or both of a second functionalised organosilicon monomer having a second ceramic yield and a functionalised organic monomer, and porous ceramic particles;
f) a first functionalised organosilicon monomer having a first ceramic yield, one or both of a second functionalised organosilicon monomer having a second ceramic yield and a functionalised organic monomer, and a porogen; and
g) a first functionalised organosilicon monomer having a first ceramic yield, one or both of a second functionalised organosilicon monomer having a second ceramic yield and a functionalised organic monomer, porous ceramic particles and a porogen.

42. The preceramic resin according to claim 40, wherein the porous ceramic particles are present, and are optionally microporous and/or mesoporous, and wherein at least 90% of the ceramic particles have a size of between about 1 nm to about 1 mm, as determined using TEM.

43. The preceramic resin according to claim 40, wherein the first functionalised organosilicon monomer is based on an organosilicon monomer independently selected from the group consisting of:
a polysiloxane, polycarbosiloxane, polycarbosilane, polysilylcarbodiimide and a polysilazane having the following chemical structures of Formula 1, Formula 2, Formula 3, Formula 4 and Formula 5, respectively, 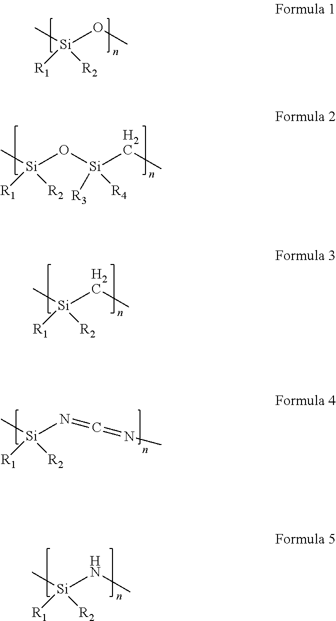
wherein:
n represents a backbone structure of repeating silicon atom-containing motifs and is independently an integer of from 2 to 15; and
R₁, R₂, R₃ and R₄ are independently selected from the group consisting of H, a C₁-C₁₈ substituted or unsubstituted alkyl, a C₁-C₁₈ substituted or unsubstituted alkyl ether, a phenyl and a halide, independently for each integer of n, with the proviso that the pairs of R₁ and R₂ and R₃ and R₄ are not both H, alkyl ether or halide for every integer of n, preferably wherein the pairs of R₁ and R₂ and R₃ and R₄ are not both H, alkyl ether or halide for any integer of n, and preferably wherein each of R₁ and R₂ and R₃ and R₄ are identical for every integer of n;
a polysilsesquioxane, polysilsesquicarbodiimide and a polysilsesquiazane substituted with one or more R¹ groups selected from the group consisting of a C₁-C₁₈ substituted or unsubstituted alkyl, a C₁-C₁₈ substituted or unsubstituted alkyl ether, a phenyl and a halide; and
a polyborosilane, a polyborosiloxane and a polyborosilazane having the following chemical structures of Formula 6, Formula 7 and Formula 8, respectively, 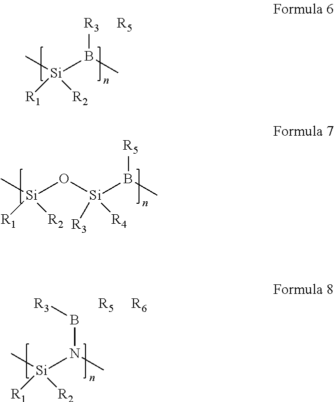
wherein:
n represents a backbone structure of repeating silicon atom-containing motifs and is independently an integer of from 2 to 15;
R₁, R₂, R₃ and R₄ are as defined above; and
R₅ and R₆ are independently selected from the group consisting of H, OH, a C₁-C₁₈ substituted or unsubstituted alkyl, a C₁-C₁₈ substituted or unsubstituted alkyl ether and a phenyl, independently for each integer of n, and preferably wherein R₅ and R₆ are identical for every integer of n.

44. The preceramic resin according to claim 40, wherein the first functionalised organosilicon monomer is functionalised with a thermal- and/or photopolymerisable functional group.

45. The preceramic resin according to claim 40, wherein the first functionalised organosilicon monomer is selected from the group consisting of methacryloxypropyl terminated polydimethylsiloxane, (mercaptopropyl)methylsiloxane homopolymer and vinylmethoxysiloxane homopolymer.

46. The preceramic resin according to claim 40, wherein the second functionalised organosilicon monomer is present and contains a polymerisable functional group that is different from, though complementary to, a polymerisable functional group of the first functionalised organosilicon monomer.

47. The preceramic resin according to claim 40, wherein the second functionalised organosilicon monomer is present and wherein the first ceramic yield and the second ceramic yield differ by about 5% or more.

48. The preceramic resin according to claim 47, wherein the second functionalised organosilicon monomer is selected from the group consisting of methacryloxypropyl terminated polydimethylsiloxane, (mercaptopropyl)methylsiloxane homopolymer, vinylmethoxysiloxane homopolymer and methacryloxypropyl substituted poly(isobutyl-t8-silsesquioxane).

49. The preceramic resin according to claim 40, wherein the functionalised organic monomer is present and has the following formula:
Spacer(L)ₙ
wherein Spacer is a spacer group, L is a reactive group reactive with at least the first functionalised organosilicon monomer, and n is an integer of greater than or equal to 2.

50. The preceramic resin according to claim 49, wherein the functionalised organic monomer is selected from the group consisting of ethylene glycol diacrylate, poly ethylene glycol diacrylate, ethylene glycol dithiol, polyethylene glycol dithiol, ethylene glycol divinyl ether, polyethylene glycol divinyl ether, ethylene glycol diallyl ether, and polyethylene glycol diallyl ether.

51. The preceramic resin according to claim 40, wherein the porogen is present and is selected from the group consisting of toluene, methanol, cyclohexanol, hexane, dodecanol, 1,2-popanediol, water, 1-propanol, 1,4-butandiol, dimethylformamide, acetonitrile, decane and decanol, polyethylene glycol (PEG), and polyethylene glycol diacrylate (PEGDA).

52. A porous polymer-derived ceramic material formed from a preceramic resin according to claim 40.

53. The porous polymer-derived ceramic material according to claim 52, characterised by a specific surface area of greater than or equal to 70 m²/g.

54. The porous polymer-derived ceramic material according to claim 52, wherein the porous polymer-derived ceramic material is micro-, meso- and/or macroporous.

55. A method for forming a porous polymer-derived ceramic material, said method comprising:
a) subjecting a preceramic resin for forming a porous polymer-derived ceramic material to polymerising conditions to form a preceramic polymer; and
b) subjecting the preceramic polymer to pyrolytic conditions,
wherein formation of the polymer-derived ceramic material from the preceramic polymer proceeds through a porous phase, and wherein the pyrolytic conditions are characterised by a maximum temperature within the porous phase.

56. A method according to claim 55, wherein the method is for forming a porous polymer-derived silica ceramic material,
wherein the pyrolytic conditions are characterised by the presence of oxygen, and wherein the preceramic resin comprises:
a) a first functionalised polycarbosiloxane or polycarbosilane monomer having a first ceramic yield; and
b) one or more of:
i. a second functionalised organosilicon monomer having by a second ceramic yield;
ii. porous ceramic particles; and
iii. a porogen.

57. A method according to claim 55, wherein the pyrolytic conditions comprise a maximum temperature of no greater than 900° C.

58. A method according to claim 55, wherein the pyrolytic conditions comprise a temperature ramp-up rate of no greater than 10° C./minute for a period within the porous phase or for a period within the temperature range of 200 to 900° C.

59. A method according to claim 55, further comprising a preliminary step of shaping the preceramic resin using a 3D printer.
